(19) United States
(12) Patent Application Publication
(10) Pub. No.: US 2021/0048053 A1
(43) Pub. Date: Feb. 18, 2021

(54) JOINED COMPONENT

(71) Applicant: POINT ENGINEERING CO., LTD., Asan (KR)

(72) Inventor: Bum Mo AHN, Suwon (KR)

(21) Appl. No.: 16/987,248

(22) Filed: Aug. 6, 2020

(30) Foreign Application Priority Data
Aug. 14, 2019 (KR) 10-2019-0099732

(51) Int. Cl. F16B 5/08; B23K 20/12

(52) U.S. Cl. CPC F16B 5/08; B23K 20/129

(57) ABSTRACT

A joined component formed by friction stir welding is proposed. More particularly, a joined component formed in a structure in which flow paths formed therein are isolated from each other without interfering with each other is proposed.

### CROSS REFERENCE TO RELATED APPLICATION

The present application claims priority to Korean Patent Application No. 10-2019-0099732, filed Aug. 14, 2019, the entire contents of which is incorporated herein for all purposes by this reference.

### BACKGROUND OF THE INVENTION

### Field of the Invention

The present invention relates to a joined component that is formed by friction stir welding and through which a process fluid passes.

### Description of the Related Art

As a technique for depositing a thin film on a semiconductor substrate or glass, chemical vapor deposition (CVD) or atomic layer deposition (ALD), which are thin-film deposition techniques based on chemical reaction, is used.

Equipment for performing thin-film deposition, such as CVD or ALD, is used to manufacture semiconductor devices. Such thin-film deposition equipment usually includes a showerhead provided inside a chamber to supply a reaction process fluid required for depositing a thin film on a wafer. The showerhead serves to spray the reaction process fluid onto the wafer in the proper distribution range required for thin film deposition.

One example of the showerhead is disclosed in Korean Patent No. 10-0769522 (hereinafter, referred to as “Patent Document 1”).

In Patent document 1, a showerhead is configured to spray a reaction gas introduced into a main hole and an auxiliary hole onto the wafer surface through a guide groove.

On the other hand, inside a vacuum chamber used for display manufacturing, a diffuser may be provided to uniformly spray gas onto glass. A display is a non-light emitting device in which liquid crystals are injected between an array substrate and a color filter substrate to obtain an image effect by using the characteristics thereof. The array substrate and the color filter substrate may be manufactured in such a manner that a thin film is repeatedly deposited onto a transparent substrate made of glass or the like, followed by patterning and etching. In this case, when a reaction material and a source material in a gaseous phase are introduced into the vacuum chamber in a deposition process, introduced gases are passed through the diffuser and deposited onto glass installed on a susceptor to form a film.

One example of the diffuser is disclosed in Korean Patent No. 10-1352923 (hereinafter, referred to as “Patent Document 2”).

In Patent Document 2, a diffuser is disposed in an upper region in the chamber to provide a deposition material onto the surface of a glass substrate.

Fluid passing members such as the showerhead of Patent Document 1 and the diffuser of Patent Document 2 may be influenced by the temperature inside an enclosed process chamber. When a fluid passing member is under influence by temperature, a temperature deviation may occur in the fluid passing member itself, which may cause deformation to occur. This may cause a problem in that the direction and density of process fluid distribution may not be uniform. In other words, when the fluid passing member is influenced by the temperature inside the process chamber, there may arise a problem in that deformation of a product may occur, which may adversely influence functions of the product.

On the other hand, in order to compensate for the adverse influence of temperature on the fluid passing member, as illustrated in FIGS. 1A and 1B, it may be considered to provide a fluid passing member, which includes a space therein capable of controlling temperature of the fluid passing member. As a method of manufacturing a fluid passing member having a space capable of controlling temperature therein, a method of welding or brazing with a metal filler material in a molten state may be used.

FIGS. 1A and 1B are views illustrating a technology underlying the present invention, in which a portion of a fluid passing member manufactured by welding or brazing a metal filler material in a molten state is shown enlarged. FIG. 1A is a view illustrating parent members 1 in a state before the method of welding or brazing with the metal filler material in a molten state is used. FIG. 1B is a view illustrating a part of the fluid passing member manufactured by the method of welding or brazing with the metal filler material in the molten state.

As illustrated in FIG. 1A, grooves 2 may be formed in opposed contact surfaces of the respective parent members 1 in an opposed relationship to form temperature control spaces. The parent members 1 in which the grooves 2 are formed may be welded or brazed together using the molten metal filler material. After welding or brazing, holes 4 may be formed by use of a perforation method in regions in which no temperature control space is formed.

However, the above technology is a method of welding or brazing with in a molten state by using a metal filler (e.g., filler metal in case of welding). Therefore, when a process fluid is injected into the holes, the metal filler material of weld joints or braze joints 3 formed between the parent members 1, may be exposed to the process fluid leading to increased corrosion. In detail, the above technology is characterized in that the weld joints or braze joints 3 also exist on inner surfaces of the holes 4. The weld joints or braze joints 3 may undergo corrosion by exposure to the process fluid passing through the inner surfaces of the holes 4.

The weld joints or braze joints 3 may be interfaces between the parent members 1. When corrosion occurs at such an interface, foreign matter resulting from corrosion may be transferred to the temperature control spaces, i.e., the grooves 2, along the interface. This may result in occurrence of serious functional errors of the temperature control spaces. When a functional error of the temperature control spaces occurs, there may arise a problem in that temperature distribution of the fluid passing member may become uneven, which may cause positional deformation of the holes 4 and further cause deformation of a product itself.

Furthermore, in the fluid passing member such as the showerhead of Patent Document 1 and the diffuser of Patent Document 2, fluid holes formed in communication with the grooves 2 and through which a process fluid different from the process fluid passing through the holes 4 passes may be provided. Therefore, a structure that sprays different process fluids may be formed.

However, the fluid passing member of the above technology is problematic in that in the structure that sprays different process fluids, the metal filler material of the weld joints or braze joints 3 may be exposed to the process fluids and corrosion may be increased at the interfaces. This may cause a problem that when the process fluids are sprayed, particles resulting from corrosion may be sprayed theretogether. As a result, this not only adversely influences formation of a film on a wafer or glass but may also result in production of defective products.

As such, according to the technology underlying the present invention, a conventional welding method has disadvantages that may cause various problems.

The foregoing is intended merely to aid in the understanding of the background of the present invention, and is not intended to mean that the present invention falls within the purview of the related art that is already known to those skilled in the art.

### Documents of Related Art

(Patent document 1) Korean Patent No. 10-0769522

(Patent document 2) Korean Patent No. 10-1352923

### SUMMARY OF THE INVENTION

Accordingly, the present invention has been made keeping in mind the above problems occurring in the related art, and an objective of the present invention is to provide a joined component, wherein a hollow channel and a hole through which a process fluid is sprayed are formed not to communicate with each other by friction stir welding, and lower openings of holes are uniformly arranged at a regular pitch.

In order to achieve the above objective, according to one aspect of the present invention, there is provided a joined component formed by welding at least two parent members by friction stir welding, the joined component including: a hollow channel formed inside the joined component and including a temperature control medium therein; and a hole passing through the parent members from top to bottom and through which a first process fluid passes, wherein a weld zone formed by the friction stir welding may remove at least a part of an interface between the hollow channel and the hole, and the hole may pass through a remaining region except for a unwelded interface existing in a hollow channel region in which the hollow channel is formed.

Further, the hole may pass through the parent members from top to bottom and may be configured such that upper and lower portions of the hole are not located on the same vertical line but are located eccentrically with respect to each other.

Further, at least a part of the hole may be formed to be inclined.

Further, the hole may be configured such that a lower section located at a lower portion of the joined component is formed within a range of a vertical projection region of an interface of the parent members.

Further, the hole may be formed to be inclined within a range of a vertical projection region of the unwelded interface of the parent members.

Further, the hole may include as a plurality of holes, and the holes may be configured such that respective lower sections thereof located at a lower portion of the joined component are arranged at a regular pitch.

Further, at least a part of the hole may pass through the weld zone formed by the friction stir welding.

Further, the parent members may include: a first parent member including a first groove region in which a first groove is formed and a first non-groove region in which the first groove is not formed; a second parent member located on one surface of the first parent member, and including a second groove region in which a second groove is formed and a second non-groove region in which the second groove is not formed; and a third parent member located on one surface of the second parent member, wherein the hollow channel may be formed as a plurality of layers inside the joined component by the first groove and the second groove.

Further, the weld zone formed by the friction stir welding may include weld zones formed along respective hollow channels such that an overlap portion is formed by the weld zones that overlap with each other at least partially.

The joined component may further include: a communication line formed inside the joined component and being in communication with the hollow channel.

Further, the temperature control medium may be a fluid or a heating wire.

Further, the temperature control medium may be a heating or cooling medium.

According to another aspect of the present invention, there is provided a joined component formed by welding at least two parent members by friction stir welding, the joined component including: a first fluid hole passing through the parent members from top to bottom and through which a first process fluid passes; and a second fluid hole being in communication with a first hollow channel formed inside the joined component, and through which a second process fluid passes, wherein a weld zone formed by the friction stir welding may remove at least a part of an interface between the first and second fluid holes, and the first fluid hole may pass through a remaining region except for a unwelded interface existing in a first hollow channel region in which the first hollow channel is formed.

Further, the first fluid hole may pass through the parent members from top to bottom and may be configured such that upper and lower portions of the first fluid hole are not located on the same vertical line but are located eccentrically with respect to each other.

Further, at least a part of the first fluid hole may be formed to be inclined.

Further, the first fluid hole may be configured such that a lower section located at a lower portion of the joined component is formed within a range of a vertical projection region of an interface of the parent members.

Further, the first fluid hole and the second fluid hole may include a plurality of first fluid holes and a plurality of second fluid holes, respectively, and the first and second fluid holes may be configured such that respective lower sections thereof located at a lower portion of the joined component are arranged at a regular pitch and different process fluids are supplied through the first and second fluid holes separately.

The joined component may further include a second hollow channel formed inside the joined component and including a temperature control medium therein.

Further, the weld zone formed by the friction stir welding may include weld zones configured such that an overlap portion is formed by the weld zones that overlap with each other at least partially.

The joined component may further include a communication line formed inside the joined component and being in communication with the first hollow channel.

As described above, the joined component according to the present invention can be formed in a structure in which flow paths provided therein are not in communication with each other by a weld zone. The joined component can also be formed in a structure in which no interface exists by the weld zone formed between the flow paths, thus making it possible to prevent adverse interaction between the paths.

Further, the openings of the holes formed in the lower portion of the joined component can be uniformly arranged at a regular pitch.

### BRIEF DESCRIPTION OF THE DRAWINGS

The above and other objectives, features, and other advantages of the present invention will be more clearly understood from the following detailed description when taken in conjunction with the accompanying drawings, in which:

FIGS. 1A to 1B are views schematically illustrating a technology underlying the present invention;

FIGS. 2A, 2B, and 2C are views schematically illustrating a first embodiment of the present invention, formed by friction stir welding which is a technical feature of the present invention;

FIGS. 3A, 3B, and 3C are views schematically illustrating a manufacturing process of a second embodiment;

FIGS. 4A and 4B are views illustrating embodiments in which a plurality of weld zones is formed between hollow channels by friction stir welding;

FIGS. 5A and 5B are views illustrating embodiments in which a hollow channel has a multi-layer structure;

FIGS. 6A, 6B, and 6C are views schematically illustrating a manufacturing process of a third embodiment of the present invention;

FIGS. 7A, 7B, and 7C are views schematically illustrating a manufacturing process of a fourth embodiment of the present invention;

FIG. 8 is a view schematically illustrating a modification of the fourth embodiment of the present invention;

FIG. 9 is a view schematically illustrating a fifth embodiment of the present invention;

FIG. 10 is a view schematically illustrating a modification of the fifth embodiment of the present invention;

FIGS. 11A to 14B are views schematically illustrating a manufacturing process of a sixth embodiment of the present invention;

FIGS. 15A, 15B, and 15C are views schematically illustrating a manufacturing process of a seventh embodiment of the present invention;

FIG. 16 is a view schematically illustrating a modification of the seventh embodiment of the present invention;

FIG. 17 is a view schematically illustrating an eighth embodiment of the present invention;

FIG. 18 is a view schematically illustrating a ninth embodiment of the present invention;

FIG. 19 is a view schematically illustrating a modification of the ninth embodiment of the present invention;

FIG. 20 is a view schematically illustrating a tenth embodiment of the present invention; and

FIGS. 21A and 21B are views schematically illustrating semiconductor or display manufacturing process equipment including the joined components of the embodiments of the present invention.

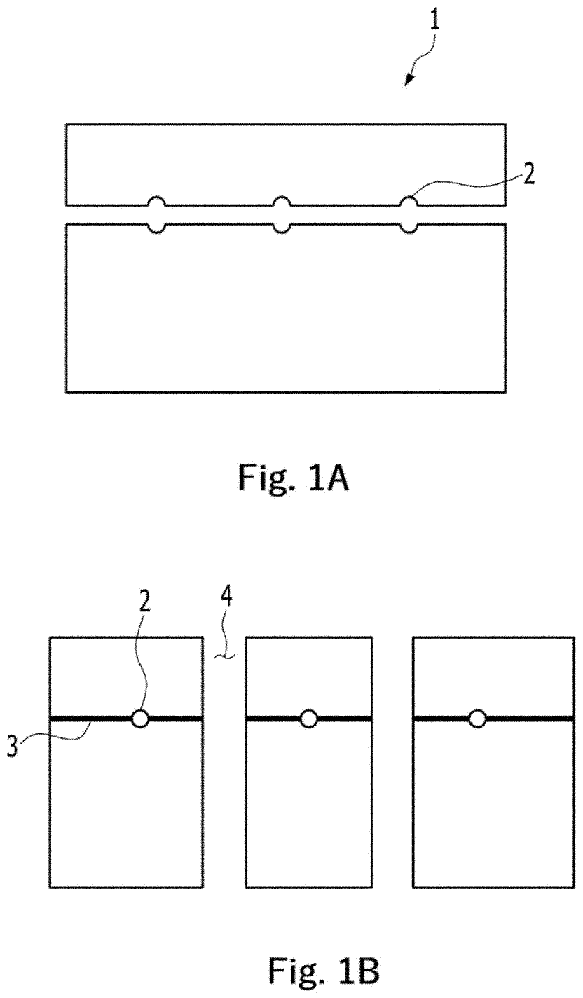

### DETAILED DESCRIPTION OF THE INVENTION

The following description merely exemplifies the principle of the present invention. Thus, although not explicitly described or shown in this disclosure, various devices in which the principle of the present invention is implemented and which are encompassed in the concept or scope of the present invention can be invented by one of ordinary skill in the art. It should be appreciated that all the conditional terms enumerated herein and embodiments are clearly intended only for a better understanding of the concept of the present invention, and the present invention is not limited to the specifically described embodiments and statuses.

The forgoing objectives, advantages, and features of invention will become more readily apparent from the following detailed description taken in conjunction with the accompanying drawings, and accordingly, one of ordinary skill in the art may easily practice the embodiment of the present invention.

Embodiments are described herein with reference to sectional and/or perspective illustrations that are schematic illustrations of idealized embodiments. Also, for convenience of understanding of the elements, in the figures, thicknesses of members and regions and diameters of holes may be exaggerated to be large for clarity of illustration. As such, variations from the shapes of the illustrations as a result, for example, of manufacturing techniques and/or tolerances, are to be expected. In addition, the number of holes shown in the drawings is by way of example only. Thus, embodiments should not be construed as limited to the particular shapes illustrated herein but are to include deviations in shapes that result, for example, from manufacturing.

Wherever possible, the same reference numerals will be used throughout different embodiments and the description to refer to the same or like elements or parts having like functions throughout. Furthermore, the configuration and operation already described in other embodiments will be omitted for convenience of the description.

A joined component according to the present invention may have a structure formed by welding at least two parent members by friction stir welding and in which no interface exists between flow paths (e.g., hollow channels, holes (fluid holes), and the like) formed in the joined component. In the case of the joined component, the structure thereof is not limited as long as a structure formed by friction stir welding and in which no interface exists between the flow paths.

The joined component may be a showerhead or diffuser capable of spraying a process fluid onto a wafer or glass in a semiconductor or display process.

In the case of placing an emphasis on the aspect of temperature control, the joined component may be provided with a temperature control medium in a hollow channel. In this case, a hole through which a process fluid is sprayed does not interfere with the hollow channel. By this structure, an adverse action between a hole and the hollow channel may be prevented.

Further, in the case of placing an emphasis on the aspect of spraying of different process fluids, the joined component may be provided with first and second fluid holes. In this case, due the structure of the joined component in which no interface exists between the flow paths, an adverse action between the first and second fluid holes occurring along an interface may be prevented.

Hereinafter, the joined component formed by friction stir welding will be exemplarily described as the diffuser capable of spraying the process fluid in the semiconductor or display manufacturing process.

Hereinafter, exemplary embodiments of the present invention will be described in detail with reference to the accompanying drawings.

### First Embodiment

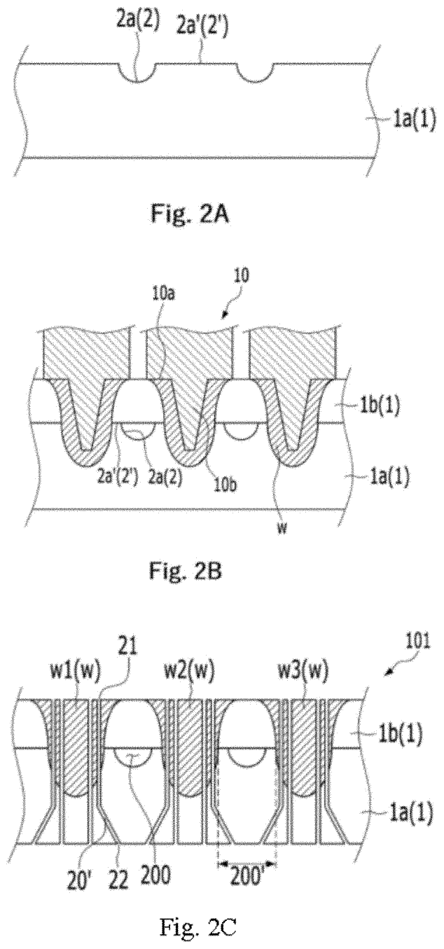

FIGS. 2A, 2B, and 2C are views schematically illustrating a joined component of a first embodiment, formed by friction stir welding which is a technical feature of the present invention. In FIGS. 2A, 2B, and 2C, at least a part of the joined component is illustrated enlarged.

The joined component 101 of the first embodiment may include at least two parent members 1, a hollow channel 200 including a temperature control medium therein, and a hole 20′ passing through the parent members 1 from top to bottom and through which a process fluid passes.

The joined component 101 may be formed by welding the at least two parent members 1 by friction stir welding. In this case, the at least two parent members 1 may be stacked on top of each other and welded by friction stir welding. In the present invention, it will be described that the at least two parent members 1 are stacked on top of each other and welded by friction stir welding, but the structure of the parent members 1 constituting the joined component 101 is not limited thereto.

When the parent members 1 are stacked on top of each other and welded, the parent members 1 may be comprised of a first parent member 1a located at a lower position, and a second parent member 1b located at an upper position.

Hereinafter, description will be given in detail with reference to FIGS. 2A, 2B, and 2C.

First, as illustrated in FIG. 2A, the first parent member 1a may be placed. A groove 2 may be formed in at least one of opposed contact surfaces of the parent members 1 constituting the joined component 101 according to the present invention. In the present invention, as an example, as illustrated in FIG. 2A, the groove 2 may be formed at the first parent member 1a. The groove 2 formed at the first parent member 1a may be a first groove 2a.

Since the groove 2 is formed in at least one of the opposed contact surfaces of the parent members 1, a space in which a fluid moves or a temperature control medium such as a heating wire is provided is provided by the groove 2 when the parent members 1 are welded by friction stir welding and formed into the joined component 101. Alternatively, a space in which a heating or cooling medium is provided may be provided. In other words, the hollow channel 200 including the temperature control medium therein may be formed inside the joined component 101 by the groove 2.

A plurality of grooves 2 may be formed in a contact surface of the first parent member 1a, so that groove regions in which the respective grooves 2 are formed and non-groove regions 2′ in which the grooves 2 are not formed may exist on the contact surface of the first parent member 1a. In other words, first groove regions in which respective first grooves 2 are formed and first non-groove regions 2a′ in which the first grooves 2 are not formed may exist on the contact surface of the first parent member 1a. At least a part of each of the non-groove regions 2′ may be an area where friction stir welding is performed. Therefore, a weld zone w formed by friction stir welding may be formed on at least a part of the non-groove region 2′.

As illustrated in FIG. 2A, the first parent member 1a in which the first grooves 2a are formed is placed, and then as illustrated in FIG. 2B, the second parent member 1b may be stacked on top of the first parent member 1a.

As illustrated in FIG. 2B, the parent members 1 may be welded by friction stir welding. Friction stir welding may be performed along a contact junction formed on at least a part of each interface between the parent members 1 to form a weld zone w, while at least a part, other than the contact junction where the weld zone w is formed, may remain unwelded.

As an example, when welding is entirely performed along interfaces between two parent members, the parent members exhibit an integrated behavior due to temperature gradient. On the other hand, as in the present invention, when friction stir welding is performed along at least a part of each of interfaces between the at least two parent members 1 and at least a part of the interface remains unwelded, the parent members 1 exhibit a separate behavior in a region except for the weld zone W. In the configuration in which the parent members 1 are partially welded, the cross-sectional area is divided into upper and lower two areas and exhibits a separate behavior in response to application of a bending force. On the contrary, in the configuration in which the parent members 1 are entirely welded, the cross-sectional area exhibits an integrated behavior in response to application of a bending force. Therefore, in the configuration in which the at least two parent members 1 are partially welded as in the present invention, it is ensured that correction of bending deformation by the temperature control medium is made more quickly, which is advantageous over the configuration in which the at least two parent members 1 are entirely welded.

Friction stir welding may be performed along the contact junction formed on at least a part of each of the interfaces between the parent members 1 to form the weld zone w. In this case, the contact junction may be an area formed by contact between each of the non-groove regions 2′ of the first parent member 1a and the second parent member 1b having a contact surface in which the grooves 2 are not formed. Therefore, friction stir welding may be performed along the contact junction between one region of the second parent member 1b at a position corresponding to at least a part of the non-groove region 2′ of the first parent member 1a to form the weld zone w whereby one region of the second parent member 1b and at least a part of the non-groove region 2′ of the first parent member 1a may be welded.

Friction stir welding is a process that joins workpieces without melting the workpiece material. Friction stir welding can reduce generation of defects such as pores, solidification cracks, and residual stresses due to a phase change from liquid to solid, which is advantageous over conventional welding or brazing. When friction stir welding is performed along the contact junction formed at each of the interfaces between the parent members 1, a pin 10b is brought into friction contact with the parent members and generates heat. In this state, a shoulder 10a coupled to an upper portion of the pin 10b is brought into contact with the parent members and expands the heating area. Then, the pin 10b or the parent members 1 are moved to cause the material under the pin 10b to plastically flow to form a nugget zone. The nugget zone is a region where recovery and recrystallization occur due to high heat and the amount of deformation. The nugget zone is also called a dynamic recrystallization zone.

Unlike general welding in which melting occurs due to heat, the nugget zone is formed through dynamic recrystallization of the material which occurs in a solid state below the melting point due to frictional heat and stirring. The diameter of the nugget zone is larger than that of the pin 10b while being smaller than that of the shoulder 10a. The size of the nugget zone depends on the speed of rotation of a welding tool 10 including the pin 10b and the shoulder 10a. As the speed of rotation increases, the size of the nugget zone decreases. However, when the speed of rotation is too high, the shape of crystal grains may be incomplete, and defects may occur at the incomplete portion. In the vicinity of the nugget zone where the parent members 1 are mixed during friction stir welding, a thermo-mechanically affected zone (TMAZ) surrounding the nugget zone is formed, and a heat affected zone (HAZ) surrounding the thermo-mechanically affected zone is formed.

The thermo-mechanically affected zone is a region where partial recrystallization occurs due to plastic deformation caused by friction at a contact surface where the shoulder 10a of the welding tool 10 is brought into contact with the parent members, and where thermal deformation due to friction and mechanical deformation due to the shoulder 10a simultaneously occur. In the thermo-mechanically affected zone, crystals softened due to excessive plastic flow and deformation of the material may be distributed at an angle.

The heat affected zone is a region more affected by heat than the thermo-mechanically affected zone, in which slant crystal grains are present and many pores are present.

The weld zone w formed by friction stir welding may be a region including the nugget zone, the thermo-mechanically affected zone, and the heat affected zone. Preferably, the weld zone w is a region where the nugget zone and the thermo-mechanically affected zone are formed below each of the interfaces between the parent members 1, or a region where the nugget zone is formed below each of the interfaces between the parent members 1.

The material of the parent members 1 may be any material enabling that: i) frictional heat is generated by friction between the pin 10b rotating at a high speed and the parent members 1, ii) the parent members 1 around the pin 10b are softened by the frictional heat, and iii) the parent members 1 are forcibly mixed together by plastic flow of the parent members 1 occurring on the joined surfaces by a stirring action of the pin 10b. The material of the parent members 1 constituting the joined component 101 may be made of at least one of aluminum, aluminum alloy, titanium, titanium alloy, magnesium, magnesium alloy, carbon steel, and stainless steel. However, the material of the parent members 1 is not limited to the above materials.

When the at least two parent members 1 are welded by friction stir welding, the at least two parent members 1 may be made of different metal materials. For example, when the first parent member 1a is made of aluminum, which is one of the above materials, the second parent member 1b may be made of stainless steel. On the other hand, the parent members 1 may be made of the same metal material. For example, when the first parent member 1a is made of aluminum, the second parent member 1b may also be made of aluminum, and when the first parent member 1a is made of stainless steel, the second parent member 1b may also be made of stainless steel. Friction stir welding is a solid-state joining process, and thus members having different melting points can be stably joined. In other words, it is possible to stably join different metal materials. In particular, the nugget zone included in the weld zone w is a region in which dynamic recrystallization occurs, and thus the nugget zone has a structure resistant to external vibrations and impacts. Furthermore, the thermo-mechanically affected zone included in the weld zone w is a region in which the parent members 1 are mixed and joined, and thus the thermo-mechanically affected zone has a structure resistant to external vibrations and impacts. Unlike other welding processes such as a welding process of joining a metal filler material in a molten state, a brazing process, and the like, friction stir welding does not require a heat source, a welding rod, a filler metal, and the like, and thus no harmful rays or harmful substances are emitted during welding. Furthermore, dynamic recombination occurs and thus it is possible to prevent solidification cracks which may occur in conventional welding, and there is little deformation and thus mechanical properties are excellent.

According to the present invention, it is ensured that the weld zone w having such a high strength and weldability is formed inside the joined component 101. By removing at a least a part of an interface between the hollow channel 200 including the temperature control medium therein and the hole 20′ through which the process fluid passes, it is also ensured that particles generated inside the hole 20′ are prevented from moving to the hollow channel 200.

It is further ensured that the process fluid passing through the hole 20′ is prevented from penetrating along the interface to reach the hollow channel 200, and the temperature control medium such as a fluid passing through the hollow channel 200 is prevented from penetrating along the interface to reach the hole 20′.

Further, in the present invention, the weld zone w may make it easy to form the hole 20′ in a structure in which the hole 20′ is isolated from the hollow channel 200 so that the hole 20′ does not interfere with the hollow channel 200 while not causing an adverse action therebetween.

As illustrated in FIG. 2C, friction stir welding may be performed along the contact junction formed on at least a part of each of the interfaces of the first and second parent members 1a and 1b to form the weld zone w on at least a part of each of the non-groove regions 2′. By formation the weld zone w formed on at least a part of the non-groove region 2′, each of the groove regions in which an associated one of the grooves 2 exists may be formed. In the groove region, the groove 2, and at least a part of each of the interfaces of the parent members 1 where friction stir welding is not performed may exist. In this case, since the hollow channel 200 is formed in the joined component 101 by the groove 2, the groove region may mean a hollow channel region 200′. Therefore, the hollow channel region 200′ may be a region including the hollow channel 200, and at least a part of each of the interfaces of the parent members 1 where friction stir welding is not performed.

The hollow channel region 200′ may be formed in a structure that is isolated from the hole 20′ by the weld zone w. Therefore, the hollow channel region 200′ may have a shape that is isolated by the weld zone w. Further, the hollow channel region 200′ may have a shape that is surrounded by adjacent weld zones w, so that even when the hole 20′ is formed while passing through each of the weld zones w, the hollow channel region 200′ may be isolated from the hole 20′ by at least a part of the weld zone w.

The weld zone w may have the hole 20′ passing through the weld zone w. The hole 20′ passing through the weld zone w may be smaller in width than the weld zone w. Therefore, the hole 20′ may have a shape formed within the range of the weld zone w. The hole 20′ formed within the range of the weld zone w may have a shape in which the periphery thereof is surrounded by at least parts of the weld zone w. Therefore, it is possible to block particles generated at the interfaces of the parent members 1 and adverse factors moving along the interfaces from flowing into the hole 20′.

The hole 20′ formed in the weld zone w may be formed by passing through the parent members 1 from top to bottom.

As illustrated in FIG. 2C, the hollow channel region 200′ may have a structure surrounded by the adjacent weld zones w formed by friction stir welding. Due to such a structure, when the hole 20′ passing through each of the weld zones w from top to bottom is formed, a structure in which the weld zone w is provided between the hollow channel 200 and the hole 20′ may be formed. Therefore, it is possible to prevent mutual physical and chemical actions between the hollow channel 200 and the hole 20′.

As illustrated in FIG. 2C, in the first embodiment, the region where the hole 20′ is formed is the weld zone w formed by friction stir welding in which frictional heat is generated by friction between the pin 10b and the parent members 1, the parent members 1 around the pin 10b are softened by the frictional heat, and the parent members 1 are forcibly mixed together by plastic flow of the parent members 1 occurring on joined surfaces by a stirring action of the pin 10b. Therefore, an interface between the parent members 1 in the weld zone w is removed because the parent members are forcibly mixed. Therefore, when the hole 20′ passing through the weld zone w while passing through the parent members 1 from top to bottom is formed, the hole 20′ may be formed in a structure that does not interfere with the hollow channel 200 and prevents an adverse action therebetween.

The hole 20′ passing through the parent members 1 from top to bottom may be formed to pass through at least a part of the weld zone w while passing through a remaining region except for a unwelded interface existing in the hollow channel region 200′. In other words, at least a part of the hole 20′ formed in the joined component 101 may be formed to pass through the weld zone w formed by friction stir welding.

In FIG. 2C, although the hole 20′ is illustrated to be formed to pass through the weld zone w while passing through the remaining region except for the unwelded interface existing in the hollow channel region 200′, the structure of the hole 20′ is not limited thereto. For example, the hole 20′ may be formed not to pass through the weld zone w while passing through the remaining region except for the unwelded interface existing in the hollow channel region 200′.

In this case, since the hole 20′ does not pass through the unwelded interface existing in the hollow channel region 200′, the hole 20′ may be formed in a structure that does not interfere with the hollow channel 200 and blocks physical and chemical interactions with the hollow channel 200. In particular, the hole 20′ is fluidly isolated from the hollow channel 200 so that the hole 20′ and the hollow channel 200 do not fluidly interfere with each other.

The hole 20′ formed in the joined component 101 is formed in a structure that does not fluidly interfere with the hollow channel 200. A plurality of holes 20′ may be formed in the joined component 101. Preferably, a hole 20′ formed at a position adjacent to the hollow channel 200 passes through the parent members 1 from top to bottom and is configured such that upper and lower portions of the hole 20′ are not located on the same vertical line but are located eccentrically with respect to each other. Therefore, among the holes 20′ formed in the joined component 101, the hole 20′ formed at a position adjacent to the hollow channel 200 may be configured in a combination shape of a vertical shape and a diagonal shape or in a diagonal shape to form a structure passing through the parent members 1 from top to bottom.

The holes 20′ formed in the joined component 101 may be configured such that respective lower openings 22 of the holes 20′ are arranged at a regular pitch in order to uniformly spray the process fluid passing through the holes 20′ onto a spray target (e.g., a wafer in a semiconductor manufacturing process or glass in a display manufacturing process).

In detail, each of the holes 20′ may include an upper opening 21 allowing the process fluid to be supplied into the hole 20′ and a lower opening 22 allowing the process fluid having passed through the hole 20′ to be sprayed onto the spray target.

In this case, the holes 20′ may be configured such that the respective lower openings 22 of the holes 20′ are arranged at a regular pitch in order to uniformly spray the process fluid through the holes 20′ onto the spray target. Therefore, the joined component 101 may have a structure in which respective lower sections of the holes 20′ located at a lower portion of the joined component 101 are arranged at a regular pitch.

When the lower sections of the holes 20′ located at the lower portion of the joined component 101 are arranged at a regular pitch, at least one of the lower sections of the holes 20′ located at the lower portion of the joined component 101 may be located at a lower portion of the hollow channel region 200′. In other words, the lower section of the hole 20′ located at the lower portion of the joined component 101 may be formed within the range of a vertical projection region of a unwelded interface of the parent members 1.

In this case, in order for the hole 20′ to be formed in a structure that does not interfere with the hollow channel 200, the hole 20′ may be formed to pass through the remaining region except for the unwelded interface existing in the hollow channel region 200′.

Due to such a structure, as illustrated in FIG. 2C, the hole 20′ may pass through the parent members 1 from top to bottom and may be configured such that upper and lower portions of the hole 20′ are not located on the same vertical line but are located eccentrically with respect to each other. In detail, the hole 20′ formed within the range of the vertical projection region of the hollow channel region 200′ may be configured such that the upper and lower portions of the hole 20′ are not located on the same vertical line but are located eccentrically with respect to each other.

As illustrated in FIG. 2C, each of the holes 20′ passing through the parent members 1 from top to bottom may be configured such that an inner flow path of the hole 20′ passes through at least a part of each of the adjacent weld zones w forming the hollow channel region 200′ so that the hole 20′ has a structure passing through the remaining region except for the unwelded interface existing in the hollow channel region 200′.

As an example, as illustrated in FIG. 2C, a part of the holes 20′ may be formed to be inclined, so that the lower opening 22 of the hole 20′ may be formed at the lower portion of the hollow channel region 200′.

As illustrated in FIG. 2C, among the holes 20′ formed in the joined component 101, the hole 20′ formed at a position adjacent to the hollow channel region 200′ may be formed in a combination shape of a vertical shape and a diagonal shape, and a hole 20′ formed at a position other than the above position adjacent to the hollow channel 200 may be formed in a vertical shape or in a combination shape of a vertical shape and a diagonal shape.

A part of the holes 20′ passing through the parent members 1 from top to bottom may be formed to be at least partially inclined to form a structure that does not interfere with the hollow channel 200. In other words, the hole 20′ may have at least a part formed to be inclined. Preferably, the hole 20′ passing through the parent members 1 from top to bottom at a position adjacent to the hollow channel region 200′ is formed to be at least partially inclined so as not to interfere with the hollow channel 200.

The hole 20′ formed at a position adjacent to the hollow channel region 200′ may have a shape in which the lower opening 22 located at the lower portion of the joined component 101 is formed within the vertical projection region of the unwelded interface of the parent members 1, so that the hole 20′ may be inclined within the range of the vertical projection region.

As illustrated in FIG. 2C, holes 20′ formed at positions adjacent to each hollow channel region 200′ on the respective left and right sides (in the drawing) of the hollow channel region 200′ may be formed in a shape that does not interfere with the hollow channel 200 of the hollow channel region 200′ and with the interfaces of the parent members 1 existing in the hollow channel region 200′. Each of the holes 20′ may be configured such that a vertical section thereof extends from a top surface to an intermediate portion of the joined component 101 and a diagonal section thereof extends from the intermediate portion to a bottom surface of the joined component 101. Therefore, the holes 20′ may be formed in a structure in which the respective lower openings 22 of the holes 20′ are formed at a regular pitch, and the holes 20′ are isolated from the hollow channel 200 without interfering therewith.

Among the holes 20′ formed in the joined component 101, a hole 20′ formed at a position adjacent to the hollow channel region 200′ may be formed in a structure that does not interfere with the hollow channel 200 of the hollow channel region 200′. In this case, in order for the hole 20′ to be formed in the remaining region except for the unwelded interface existing in the hollow channel region 200′, the hole 20′ may be configured such that a vertical section thereof extends from the top surface to the intermediate portion of the joined component 101 and a diagonal section thereof extends from the intermediate portion to the bottom surface of the joined component 101. Remaining holes 20′ formed at positions other than the above positions adjacent to the hollow channel region 200′ may be formed in a suitable shape including a vertical shape, a diagonal shape, or a combination shape of a vertical shape and a diagonal shape, in which the respective lower openings 22 of the holes 20′ are arranged at a regular pitch.

As described above, each of the holes 20′ formed in the joined component 101 of the first embodiment may be formed while passing through the remaining region except for the unwelded interface existing in the hollow channel region 200′.

In FIG. 2C, among holes 20′ formed in a remaining region except for the hollow channel region 200′, a plurality of holes 20′ formed in each weld zone w may be formed to be symmetrical to each other with respect to a center line vertically disposed on a plane of the hollow channel region 200′.

In detail, as an example, when a weld zone w formed on the left side in FIG. 2C is referred to as a first weld zone w1, a second weld zone w2 and a third weld zone w3 may be formed sequentially to the right side.

In this case, in the first weld zone w1, a hole 20′ having a combination shape of a vertical shape and a diagonal shape and a hole 20′ having a vertical shape may be formed alternately, and holes 20′ symmetrical to these holes 20′ may be formed with respect to a center line vertically disposed on a plane of the first weld zone w1.

The plurality of holes 20′ formed through the first weld zone w1 may be symmetrical to a plurality of holes 20′ formed through the second weld zone w2 with respect to a center line vertically disposed on a plane of the hollow channel region 200′. Further, a plurality of holes 20′ may be formed in the third weld zone w3 in a shape symmetrical to the plurality of holes 20′ formed in the second weld zone w2 with respect to a center line vertically disposed on a plane of the hollow channel region 200′ formed at a position adjacent to the second weld zone w2 on the right side in FIG. 2C of the second weld zone w2.

In this case, the number and shape of the holes 20′ formed in each of the weld zones w1, w2, and w3 are only one example and are not limited thereto. However, forming the holes 20′ in a symmetrical shape with respect to the vertically disposed center line may be a more efficient method of forming the holes 20′. In the present invention, as described above, due to the structure in which the holes 20′ are efficiently formed while avoiding fluid interference with the hollow channel 200, the holes 20′ may be formed in a symmetrical shape with respect to a center line disposed on any one plane.

On the other hand, the holes 20′ formed in the joined component 101 of the first embodiment may be configured such that a vertical section of the each of the holes 20′ extending from the top surface to the intermediate portion of the joined component 101 is formed as a common hole, and the common hole is branched to form a plurality of lower openings 22 located at the lower portion of the joined component 101. In other words, one hole 20′ may include a common hole and at least two branch holes so that respective openings of the branch holes are arranged at a regular pitch at the lower portion of the joined component 101. In this case, in order to uniformly supply the process fluid supplied to the hole 20′ to the branch holes, the branch holes may be formed with the same inner diameter, and the inner diameter of the common hole connected to the branch holes may be greater (preferably 2 times) than that of each of the branch holes. Therefore, the process fluid supplied to the common hole may be evenly distributed to the branch holes.

When the hole 20′ includes the common hole and the branch holes, the common hole may be configured to communicate with an upper opening of the hole 20′, and the branch holes may be configured to communicate with lower openings of the hole 20′. In this case, the branch holes may be configured such that the lower openings are arranged at a regular pitch.

The hole 20′ including the common hole and the branch holes may be formed to pass through the remaining region except for the unwelded interface existing in the hollow channel region 200′. The hole 20′ may pass through the parent members 1 from to bottom and may be configured such that due to the structure in which the branch holes are branched from a lower portion of the common hole, upper and lower portions of an inner flow path of the hole 20′ are not located on the same vertical line but are located eccentrically with respect to each other. Further, the hole 20′ including the common hole and the branch holes may be formed in a structure that does not pass through each of the interfaces of the parent members 1 without interfering with the hollow channel 200 of the hollow channel region 200′.

As described above, in the joined component 101 according to the present invention, the hole 20′ formed therein has a structure that passes through the remaining region except for the unwelded interface existing in the hollow channel region 200′. Due to this, it is possible to prevent an adverse action from occurring between the hole 20′ and the hollow channel 200 existing in the hollow channel region 200′ due to the unwelded interface due to the structure in which the hole 20′ fluidly interferes with the hollow channel 200 existing in the hollow channel region 200′.

The temperature control medium may be provided in the hollow channel 200 formed inside the joined component 101. In this case, since the hollow channel 200 is formed by the groove 2 provided in at least one of the contact surfaces of the parent members 1, the hollow channel 200 may be provided in at least one of the contact surfaces of the parent members 1. Therefore, the temperature control medium provided in the hollow channel 200 may be provided in at least one of the contact surfaces of the parent members 1.

The temperature control medium may perform a temperature control function of controlling product temperature inside the joined component 101. Therefore, it is possible to ensure uniformity of the temperature of the joined component 101, thus minimizing problems of product deformation and loss of function due to product deformation.

The temperature control medium provided in the hollow channel 200 may be a fluid or a heating wire.

When the temperature control medium is the fluid or the heating wire, since the hollow channel 200 including the temperature control medium therein is formed in a structure that is isolated from the holes 20′ through which the process fluid passes by the weld zone w, an adverse action or an adverse influence may not occur between the hollow channel 200 and the hole 20′.

The temperature control medium provided in the hollow channel 200 may be a heating or cooling medium.

When the temperature control medium is the heating medium, the joined component 101 may function as a heating block having a heating function. On the other hand, when the temperature control medium is the cooling medium, the joined component 101 may function as a cooling block having a cooling function.

The temperature control medium as described above may be provided in a built-in form in the hollow channel 200 formed in at least one of the contact surfaces of the parent members 1.

The joined component 101 according to the present invention is preferably used in a semiconductor manufacturing process or a display manufacturing process. In this case, the joined component 101 may be formed in a structure in which the lower openings 22 of the holes 20′ are regularly arranged at a regular pitch in order to uniformly spray the process fluid onto the spray target. The joined component 101 according to the present invention may include the hollow channel 200 including the temperature control medium therein to ensure uniformity of product temperature. In this case, to form a structure in which the lower openings 22 of the holes 20′ are arranged at a regular pitch while the holes 20′ and the hollow channel 200 do not interfere with each other, as described with reference to FIG. 2C, each of the holes 20′ is preferably formed to pass through the remaining region except for the unwelded interface existing in the hollow channel region 200′.

In the present invention, to form such a structure, the parent members 1 may be welded by friction stir welding to form the weld zone w. In the joined component 101 according to the present invention, it is possible to efficiently form a structure capable of uniformly spraying the process fluid while in which the holes 20′ and the hollow channel region 200′ may be isolated from each other by the weld zone w and the holes 20′ may not fluidly interfere with the hollow channel 200 of the hollow channel region 200′.

In other words, in the present invention, a structure that enables the configurations (e.g., the holes 20′ and the hollow channel 200) provided in the joined component 101 to perform their respective functions faithfully, while blocking an adverse action between the configurations. Therefore, it is possible to obtain an effect of ensuring uniformity of product temperature and increasing efficiency of process fluid spray.

### Second Embodiment

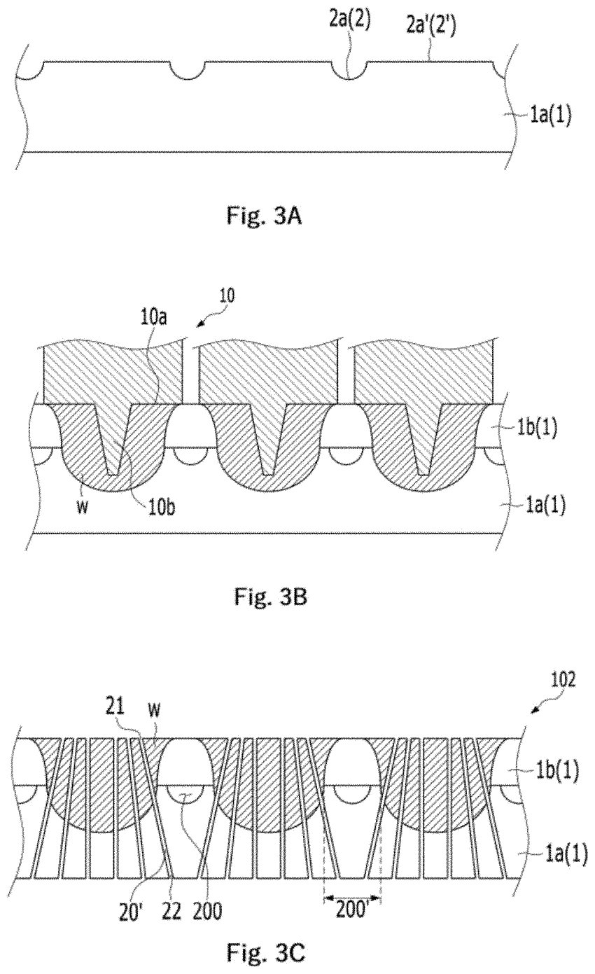

FIGS. 3A, 3B, and 3C are views schematically illustrating a manufacturing process of a joined component 102 according to a second embodiment of the present invention. The joined component 102 of the second embodiment differs from the first embodiment in that a hole 20′ formed at a position adjacent to a hollow channel region 200′ is formed in a diagonal shape. The embodiments described below will be mainly described in terms of characteristic components in comparison with the first embodiment, and descriptions of the same or similar components to the first embodiment will be omitted.

As illustrated in FIG. 3A, a first parent member 1a in which a first groove 2a is formed is placed.

Then, as illustrated in FIG. 3B, a second parent member 1b is placed on top of the first parent member 1a, and then friction stir welding may be performed along each contact junction. A weld zone w may be formed thereby at the contact junction.

Then, as illustrated in FIG. 3C, a hole 20′ may be formed to pass through a remaining region except for an unwelded interface existing in the hollow channel region 200′ in which a hollow channel 200 is formed.

In this case, the hole 20′ may be formed to be inclined while passing through parent members 1 from top to bottom. A plurality of holes 20′ may be formed in the joined component 102. Preferably, a hole 20′ formed at a position adjacent to the hollow channel region 200′ may be formed to be inclined in a diagonal shape so as not to fluidly interfere with the hollow channel 200.

Respective lower openings 22 of the holes 20′ located at a lower portion of the joined component 102 may be arranged at a regular pitch. Due to such a structure, at least one of the lower openings 22 of the holes 20′ of the joined component 102 may be located at a lower portion of the hollow channel region 200′. In this case, in order to form the hole 20′ so as to pass through the remaining region except for the unwelded interface existing in the hollow channel region 200′ without fluidly interfering with the hollow channel 200, as illustrated in FIG. 3C, at least a part of the hole 20′ may be formed to pass through the parent members 1 from top to bottom in a diagonal shape while passing through the weld zone w.

In this case, the shape of the hole 20′ passing through the parent members 1 from top to bottom in a diagonal shape is preferably the same as the shape of the hole 20′ formed a position adjacent to the hollow channel region 200′. Remaining holes 20′ except for the hole 20′ formed at a position adjacent to the hollow channel region 200′ may be formed in a suitable shape (e.g., a vertical shape, a diagonal shape, or a combination shape of a vertical shape and a diagonal shape) in which the respective lower openings 22 of the holes 20′ are arranged at a regular pitch.

As illustrated in FIG. 3C, holes 20′ formed at positions adjacent to each hollow channel region 200′ on the respective left and right sides (in the drawing) of the hollow channel region 200′ may be formed in a shape that does not fluidly interfere with the hollow channel 200 of the hollow channel region 200′ and with the interfaces of the parent members 1 existing in the hollow channel region 200′. In this case, each of the holes 20′ may be formed in a structure in which the hole 20′ passes through the parent members 1 from top to bottom in a diagonal shape, with at least a part thereof passing through the weld zone w.

As illustrated in FIG. 3C, the hollow channel region 200′ may be located between the diagonal holes 20′ that are adjacent to the hollow channel region 200′ on the left and right sides of the hollow channel region 200′. In this case, the hollow channel region 200′ and the holes 20′ may be separated from each other by the weld zone w into regions that do not fluidly interfere with each other. The hollow channel region 200′ isolated by the weld zone w and the holes 20′ may be blocked from an adverse action due to interfaces existing between the hollow channel region 200′ and the holes 20′.

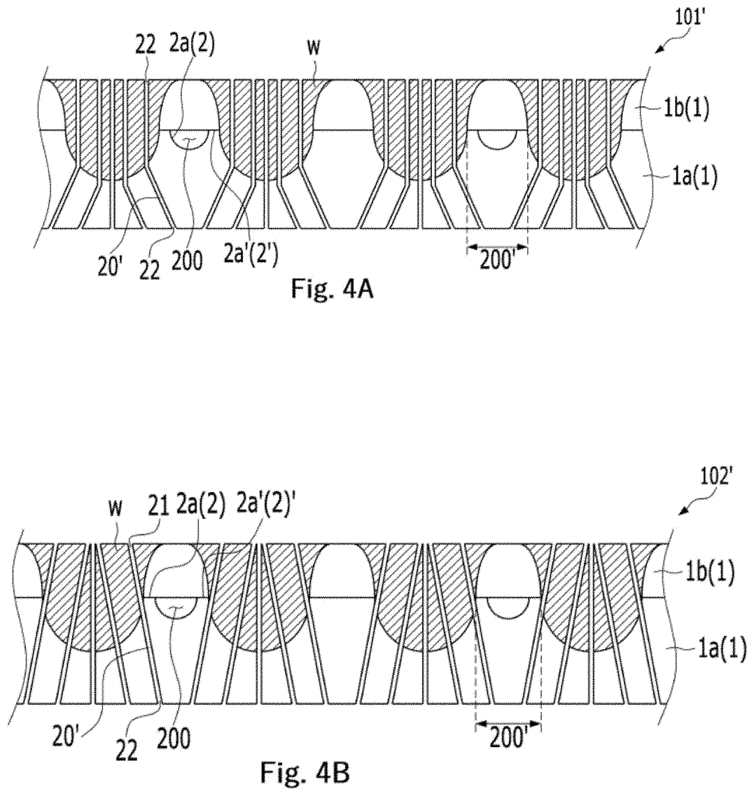

FIGS. 4A and 4B are views illustrating embodiments in which a plurality of weld zones is formed between hollow channels by friction stir welding.

In the first and second embodiments referring to FIGS. 2A, 2B, 2C and FIGS. 3A, 3B, and 3C, one weld zone w is formed between hollow channels 200, so that holes 20′ located in the periphery of the hollow channel regions 200′ passes through the weld zone w. In detail, the holes 20′ of each of the joined components 101 and 102 are formed to pass through the parent members 1 from top to bottom while passing through the weld zone w.

Unlike this, FIGS. 4A and 4B illustrates the embodiments in which the plurality of weld zones w is formed between the hollow channels 200. The plurality of weld zones w may be formed between the hollow channels 200. As illustrated in FIGS. 4A and 4B, due to a structure in which the plurality of weld zones w is formed between the hollow channels 200, at least a part of each of interfaces of parent members 1 where friction stir welding is not performed may exist between the weld zones w formed between the hollow channels 200. Here, a hole 20′ is formed to pass through a remaining region except for an unwelded interface existing in a hollow channel region 200′ in which each of the hollow channels 200 is formed.

In such a structure, a plurality of holes 20′ may be formed in a joined component 101′. Among these holes 20′, a hole 20′ formed at a position adjacent to the hollow channel region 200′ may be formed in a combination shape of a vertical shape and a diagonal shape as in the case of the first embodiment. Alternatively, the hole 20′ formed at a position adjacent to the hollow channel region 200′ may be formed in a diagonal shape as in the case of the second embodiment.

First, as illustrated in FIG. 4A, in an embodiment in which the plurality of weld zones w is formed between the hollow channels 200, each of the holes 20′ may be formed to pass through the remaining region except for the unwelded interface existing in the hollow channel region 200′. In this case, the holes 20′ may be formed in a structure that does not fluidly interfere with the hollow channel 200 of the hollow channel region 200′, and each of the holes 20′ may be configured such that a vertical section thereof extends from a top surface to an intermediate portion of the joined component 101′ and a diagonal section thereof extends from the intermediate portion to a bottom surface of the joined component 101′.

Further, the hole 20′ may be formed to pass through a remaining region except for a unwelded interface in a region where the hollow channel 200 does not exist.

Respective lower openings 22 of the holes 20′ located at a lower portion of the joined component 101′ may be arranged at a regular pitch. To form the holes 20′ in such a structure, the holes 20′ may be formed while passing through the plurality of weld zones w existing between the hollow channels 200.

On the other hand, as illustrated in FIG. 4B, in an embodiment in which a plurality of weld zones w are formed between hollow channels 200, a hole 20′ may be formed to pass through parent members 1 from top to bottom in a diagonal shape. Also in this case, the hole 20′ may be formed to pass through a remaining region except for a unwelded interface existing in a hollow channel region 200′. Therefore, the hole 20′ may be formed in a structure that does not fluidly interfere with a hollow channel 200 and in a structure isolated from the hollow channel 200 by each of the weld zones w, which may prevent an adverse action from occurring on their respective functions.

Further, the hole 20′ may be formed to pass through a remaining region except for a unwelded interface in the region where the hollow channel 200 does not exist.

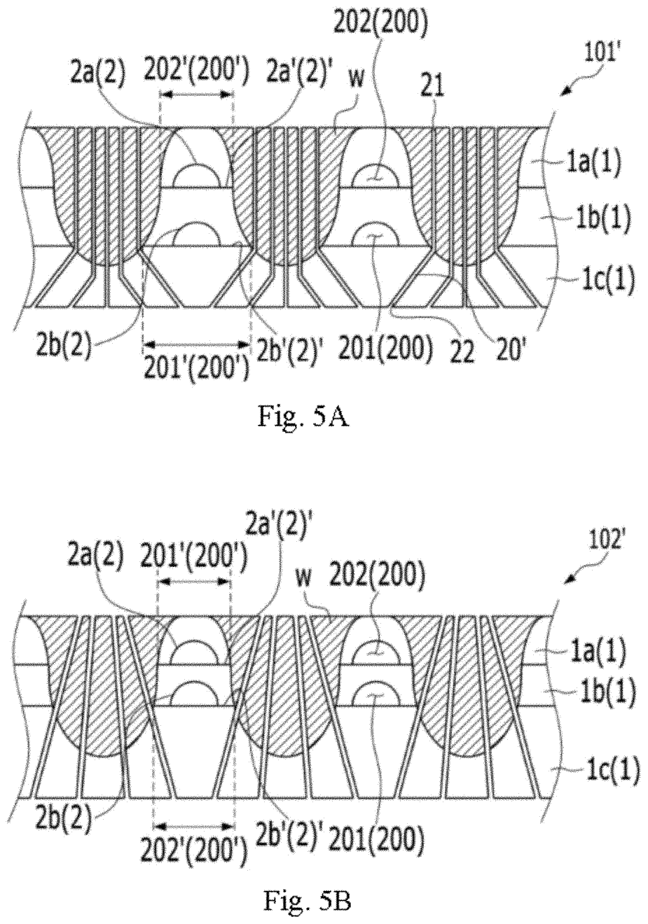

FIGS. 5A and 5B are views illustrating embodiments in which a hollow channel formed in a joined component has a multi-layer structure.

As illustrated in FIGS. 5A and 5B, in an embodiment in which the hollow channel 200 is formed in a multi-layer structure inside the joined component, the number of parent members 1 stacked on top of each may differ from the numbers of the parent members 1 of the first and second embodiments. Due to this, the hollow channel 200 may be formed as a plurality of layers inside the joined component.

In this case, the parent members 1 may include a first parent member 1 having a first groove region in which a first groove 2a is formed and a first non-groove region in which the first groove 2a is not formed, a second parent member located on one surface of the first parent member 1a and having a second groove region in which a second groove 2b is formed and a second non-groove region in which the second groove 2b is not formed, and a third parent member 1c located on one surface of the second parent member 1b.

In FIGS. 5A and 5B, it will be described that the third parent member 1c, the second parent member 1b, and the first parent member 1a are sequentially stacked on top of each other and welded by friction stir welding. The stacked structure of the parent members 1 is illustrated as an example and thus is not limited thereto.

When the hollow channel 200 is formed in a multi-layer structure inside the joined component as illustrated in FIGS. 5A and 5B, in the present invention, it will be described that the groove 2 of the first parent member 1a is formed at a position opposed to the groove 2 of each of the first and second embodiments. In this case, the formation position of the groove 2 is not limited to a specific position. For example, the groove 2 may be formed at the same position as that of each of the first and second embodiments referring to FIGS. 2A, 2B, and 2C and FIGS. 3A, 3B, and 3C.

As illustrated in FIGS. 5A and 5B, in the joined component including the hollow channel 200 having a multi-layer structure, the third parent member 1c constituting the joined component may have a communication groove instead of having a groove region. The communication groove may perform a function of communicating hollow channels provided in the same layer with each other.

In FIGS. 5A and 5B, in the hollow channel 200 having a multi-layer structure, as an example, a hollow channel 200 formed by the second groove 2b may be a first hollow channel 201, and a hollow channel 200 formed by the first groove 2a may be a second hollow channel 202. In other words, a structure in which the second hollow channel 202 is provided above the first hollow channel 201 may be formed.

As illustrated in FIGS. 5A and 5B, a first non-groove region 2a′ of the first parent member 1a, a second non-groove region 2b′ of the second parent member 1b, and one region of the third parent member 1c may be welded by friction stir welding to form a weld zone w. Then, a hole 20′ passing through the parent members 1 from top to bottom may be formed. The hole 20′ may be formed in a combination shape of a vertical shape and a diagonal shape as in the case of the first embodiment referring to FIGS. 2A, 2B, and 2C, or may be formed in a diagonal shape as in the case of the second embodiment referring to FIGS. 3A, 3B, and 3C.

First, as illustrated in FIG. 5A, the hole 20′ may be formed in a combination shape of a vertical shape and a diagonal shape and may pass through a remaining region except for a unwelded interface existing in a hollow channel region 200′.

In this case, since the hollow channel 200 has a multi-layer structure, the hollow channel region 200′ may exist by the hollow channel 200 of each layer. In detail, a first hollow channel region 201′ including the first hollow channel 201 and a second hollow channel region 202′ including the second hollow channel 202 may exist. Therefore, the hole 20′ may be formed in a combination shape of a vertical shape and a diagonal shape or in a diagonal shape to pass through a remaining region except for a unwelded interface existing in each of the hollow channel regions 201′ and 202′ of each layer.

Therefore, a joined component 101′ as illustrated in FIG. 5A may be implemented.

A plurality of holes 20′ may be formed in the joined component 101′. The holes 20′ may be formed in a structure in which respective lower openings 22 thereof are formed at a regular pitch, and the holes 20′ do not interfere with the respective hollow channels 200. This may be implemented by the above-described structure for forming the hole 20′ so as to pass through the remaining region except the unwelded interface existing in the hollow channel region 200′.

On the other hand, as illustrated in FIG. 5B, in a joined component 102′ including a hollow channel 200 having a multi-layer structure, a hole 20′ may be formed in a diagonal shape. In this case, the hole 20′ differs from the hole 20′ illustrated in FIG. 5A only in terms of shape, but remains the same in that the hole 20′ is formed to pass through a remaining region except for a unwelded interface existing in a hollow channel region 200′ of each layer.

Also in the joined component 102′ including the hollow channel 200 having a multi-layer structure as described above, the hole 20′ may be formed while passing through the remaining region except for the unwelded interface existing in the hollow channel region 200′ of each layer. A plurality of holes 20′ may be formed in the joined component 102′. In this case, regardless of the number of stacked parent members 1, the holes 20′ may be formed in a structure in which respective lower openings 22 thereof are arranged at a regular pitch and the holes 20′ do not fluidly interfere with the respective hollow channels 200, through the configuration of the shape (e.g., a combination shape of a vertical shape and a diagonal shape, and a diagonal shape) of the hole 20′.

### Third Embodiment

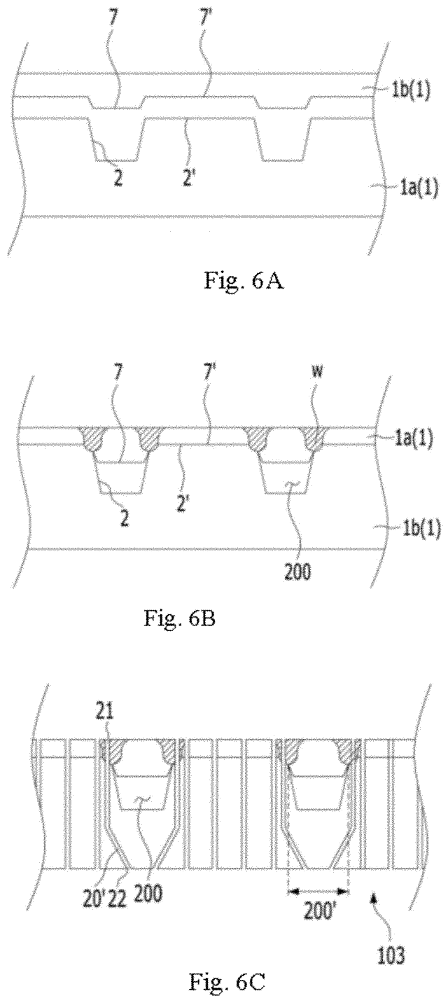

FIGS. 6A, 6B, and 6C are views schematically illustrating a manufacturing process of a joined component 103 according to a third embodiment of the present invention. The third embodiment differs from the first embodiment in that parent members 1 constituting the joined component 103 are formed in shapes capable of fitting together. Hereinafter, description will be mainly given in terms of characteristic components, and descriptions of the same or similar components to the first embodiment will be omitted.

As shown in FIGS. 6A and 6B, the parent members 1 may have shapes capable of fitting together and may first fitted together before being joined by friction stir welding.

The parent members 1 having shapes capable of fitting together may be configured such that a recessed portion such as a groove 2 is formed in a contact surface of at least one of the parent members 1, and a protrusion 7 may be formed on a contact surface of a remaining one of the parent members 1. In the third embodiment, as an example, it will be described that the groove 2 is formed in the contact surface of a first parent member 1a and the protrusion 7 is formed on the contact surface of a second parent member 1b such that the first and second parent members 1a and 1b are fitted together through engagement of the groove 2 and the protrusion 7. Therefore, the second parent member 1b may be fitted to top of the first parent member 1a. However, the shape of the parent members 1 is not limited thereto.

In addition, in the present invention, the groove 2 and the protrusion 7 have a tapered shape. However, this is only an example, and the shape of the groove 2 and the protrusion 7 is not limited thereto. Hereinafter, the parent members 1 will be described as having shapes capable of fitting together to form the joined component 103.

In the contact surface of the first parent member 1a, a groove region in which the groove 2 is formed, and a non-groove region 2′ in which the groove 2 is not formed may be provided. In the contact surface of the second parent member 1b, a protrusion region in which the protrusion 7 is formed, and a non-protrusion region 7′ in which the protrusion 7 is not formed may be provided. In this case, the groove region of the first parent member 1a and the protrusion region of the second parent member 1b may be opposed to each other, while the non-groove region 2′ of the first parent member 1a and the non-protrusion region 7′ of the second parent member 1b may opposed to each other.

The groove 2 formed in the contact surface of the first parent member 1a may be larger in depth than the protrusion 7 such that a lower surface of the protrusion 7 and a lower surface of the groove 2 do not come into contact with each other when the protrusion 7 of the second parent member 1b is fitted into the groove 2. Therefore, when the second parent member 1b is fitted to the first parent member 1a, a temperature control space may be formed between the groove 2 of the first parent member 1a and the protrusion 7 of the second parent member 1b. The temperature control space defines a hollow channel 200 inside the joined component 103 when the first and second parent members 1a and 1b are welded by friction stir welding to form the joined component 103.

When the parent members 1 are fitted together, a contact junction may be formed. Friction stir welding may be performed along the contact junction to form a weld zone w. As illustrated in FIG. 3B, friction stir welding may be performed along the contact junction between the parent members 1 to form the weld zone w.

In this case, the protrusion 7 of the second parent member 1b may be fitted into the groove 2 of the first parent member 1a. The fitting may be performed in such a manner that left and right contact surfaces of the protrusion 7 of the second parent member 1b in a width direction come into contact with left and right contact surfaces of the groove 2 of the first parent member 1a in a width direction, respectively, with the lower surface of the protrusion 7 of the second parent member 1b not coming into contact with the lower surface of the groove 2 of the first parent member 1a. Therefore, a contact junction may be formed on at least a part of a horizontal interface between the groove 2 and the protrusion 7.

Hereinafter, it will be described as an example that the parent members 1 have shapes capable of fitting together and are welded by friction stir welding. Therefore, a contact junction described below may mean the interface between the groove 2 and the protrusion 7. In addition, due to the fact that friction stir welding is performed along the contact junction to form the weld zone w, at a least a part of each horizontal interface between the parent members 1 may be included in the weld zone w.

When the second parent member 1b is fitted to the first parent member 1a, the left and right contact surfaces of the protrusion 7 of the second parent member 1b in the width direction come into contact with the left and right contact surfaces of the groove 2 of the first parent member 1a in the width direction, respectively, and contact junctions may be formed. Friction stir welding may be performed along the contact junctions to form weld zones w.

In detail, in FIG. 6B, when the left contact surface (in the drawing) of the groove 2 of the first parent member 1a in the width direction and the left contact surface (in the drawing) of the protrusion 7 of the second parent member 1b in the width direction come into contact with each other, a left contact junction may be formed on at least a part of a left interface between the groove 2 and the protrusion 7. Friction stir welding may be performed along the left contact junction to form a weld zone w.

Further, when the right contact surface of the groove 2 of the first parent member 1a in the width direction and the right contact surface of the protrusion 7 of the second parent member 1b in the width direction come into contact with each other, a right contact junction may be formed on at least a part of a right interface between the groove 2 and the protrusion 7. Friction stir welding may be performed along the right contact junction to form a weld zone W.

In the joined component according to the third embodiment, friction stir welding may be performed along the left and right contact junctions of the parent members 1 fitted together to form the respective weld zones w.

In the joined component 103 according to the third embodiment, although it is described as an example that the weld zones w are formed on the respective left and right contact junctions, the weld zones w may be formed as one weld zone w having a range within which the left contact junction and the right contact junctions are included. Herein, the one weld zone W may be larger in width than the groove 2 of the first parent member 1a and than the protrusion 7 of the second parent member 1b and may be located a position below a horizontal interface between the hollow channel 200 and a hole 20′, with a depth not exceeding the height of the protrusion 7 of the second parent member 1b.

Due to the formation of the weld zones W at the contact junctions between the parent members 1, the hollow channel 200 of the joined component 103 defined by the groove 2 of the first parent member 1a and the protrusion 7 of the second parent member 1b may have a shape that passes through an interior of the joined component 103. Such a shape of the hollow channel 200 may be formed by each of the weld zones w that removes a part of each interface between the parent members 1, the part being adjacent to the hollow channel 200. Therefore, it is possible that particles that may be introduced into the hollow channel 200 along the interface between the parent members 1 are blocked, and other adverse influences are prevented.

As illustrated in FIG. 6B, in the third embodiment, it is illustrated that a plurality of weld zones w is formed between hollow channels 200, but is not limited thereto. For example, at least one weld zone w may be formed between the hollow channels 200.

As illustrated in FIG. 6C, the hole 20′ may be formed to pass through the parent members 1 from top to bottom. In this case, the hole 20′ may be formed to pass through a remaining region except for a unwelded interface existing in a hollow channel region 200′ in which the hollow channel 200 is formed.

In the third embodiment, the weld zones w are formed on the left and right contact junctions, so that only the hollow channel 200 exists in the hollow channel region 200′. Therefore, the hole 20′ may have a structure that does not interfere with the hollow channel region 200′ in which the hollow channel 200 is formed and may be formed in a shape that passes through the parent members 1 from top to bottom while passing through each of the weld zones w existing in a remaining region except for the hollow channel region 200′.

In the third embodiment, depending on a pitch between respective lower openings 22 of a plurality of holes 20′, a hole 20′ passing through an interface of the parent members 1 may be formed, the interface being located between the plurality of weld zones w existing between the hollow channels 200. In this case, a process fluid passing through the hole 20′ may move along the interface. However, the process fluid moving along the interface flows into a hole 20′ through which the same process fluid passes, and thus there is no fear of functional error.

As illustrated in FIGS. 6B and 6C, in the third embodiment of the present invention, it is illustrated that the weld zones w are formed on the left and right contact junctions of the hollow channel 200 whereby no unwelded interface of the parent members 1 exists in the hollow channel region 200′.

On the other hand, a hollow channel region 200′ including the left and right contact junctions of the hollow channel 200 may be formed. This may be implemented by forming weld zones w on horizontal contact junctions of the parent members 1 adjacent to the left and right contact junctions. In other words, the hollow channel region 200′ including the interfaces on which the left and right contact junctions may be formed and the hollow channel 200 may be formed in a structure isolated by the weld zones w.

Also in this case, the hole 20′ may be formed to pass through a remaining region except for the unwelded interface existing in the hollow channel region 200′. Therefore, a problem of an adverse action occurring in the hollow channel region 200′ due to the process fluid may be prevented.

In the third embodiment, at least a part of the hole 20′ may pass through the weld zone w. In this case, the hole 20′ may be formed in a structure in which a vertical section thereof extends from a top surface to an intermediate portion of the joined component 103, and a diagonal section thereof inclinedly extends from the intermediate portion to a bottom surface of the joined component 103 so that the hole 20′ passes through the parent members 1 in a combination shape of a vertical shape and a diagonal shape.

Such a shape allows to efficiently form a structure in which a regular pitch between the lower openings of the holes 20′ is formed, while the holes 20′ do not interfere with the hollow channel 200.

### Fourth Embodiment

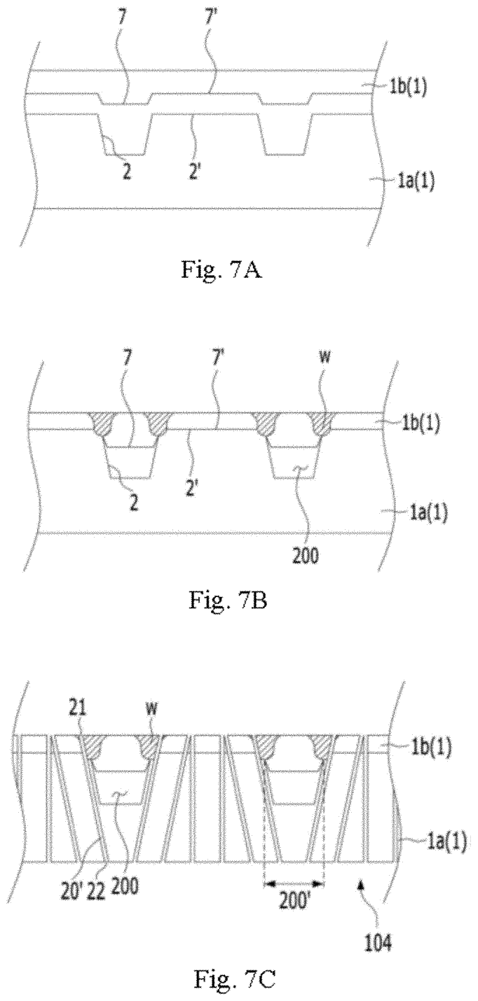

FIGS. 7A, 7B, and 7C are views schematically illustrating a manufacturing process of a joined component 104 according to a fourth embodiment of the present invention. The joined component 104 according to the fourth embodiment differs from the third embodiment in that a hole 20′ passing through parent members 1 from top to bottom is formed to be inclined in a diagonal shape.

In the fourth embodiment, as in the third embodiment, the parent members 1 may be provided in shapes capable of fitting together.

Friction stir welding may be performed along each of left and right contact junctions of the parent members 1 to form a weld zone w. The above processes are the processes illustrated in FIGS. 7A and 7B and remain the same as those described with reference to FIGS. 6A and 6B in the third embodiment, and thus a detailed description thereof will be omitted.

As illustrated in FIG. 7C, the hole 20′ may be formed to be inclined while passing through parent members 1 from top to bottom. In other words, the hole 20′ may be formed in a diagonal shape.

The hole 20′ may be formed in a remaining region except for a unwelded interface existing in a hollow channel region 200′ to form a structure that does not fluidly interfere with the hollow channel 200. Due to such a structure, depending on a pitch between respective lower openings 22 of a plurality of holes 20′, as illustrated in FIG. 7C, a hole 20′ passing through an interface of the parent members 1 may be formed, the interface being located between a plurality of weld zones w.

In this case, the shape of the hole 20′ passing through the parent members 1 from top to bottom is not limited to any one of a diagonal shape, a combination shape of a vertical shape and a diagonal shape, and a vertical shape. In other words, the hole 20′ may be formed in a suitable structure capable of forming a regular pitch between the lower openings 22 of the holes 20′.

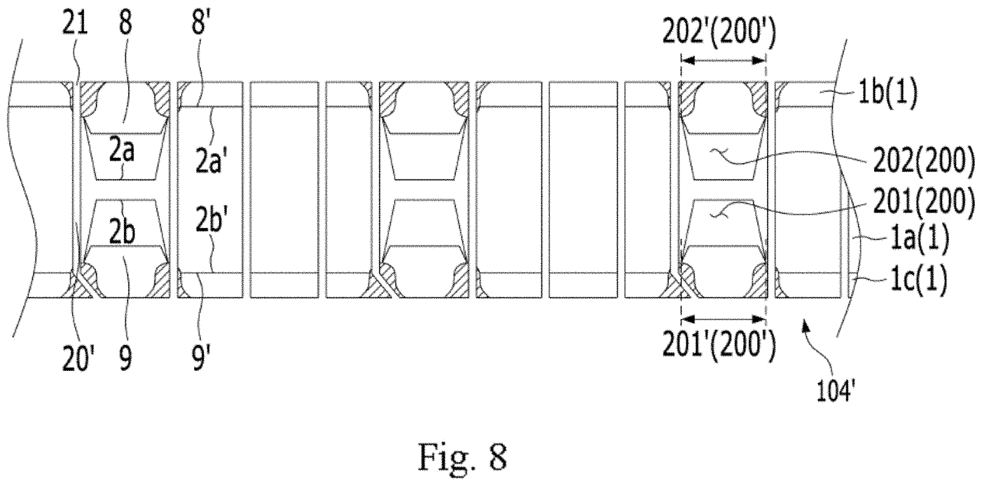

FIG. 8 is a view schematically illustrating a modification of the fourth embodiment of the present invention.

A joined component 104′ according to the modification of the fourth embodiment differs from the fourth embodiment in that the shape of a part of parent members 1 is changed, and that a hollow channel 200 is formed in a multi-layer structure. In the modification, as in the fourth embodiment, a first parent member 1a and a second parent member 1b are stacked on top of each other. However, a third parent member 1c is provided on bottom of the second parent member 1b. In this case, the shape of the parent members 1 and the form in which the parent members 1 are stacked are described as an example only, and are not limited thereto. A groove and a protrusion in the modification may differ in shape and position from those of the parent members 1 in the fourth embodiment. However, the same reference numerals are used for the sake of convenience.

The joined component 104′ according to the modification may include: the first parent member 1a including an upper contact surface (in the drawing) provided with a first groove region in which a first groove 2a is formed and a first non-groove region 2a′ in which the first groove 2a is not formed, and a lower contact surface (in the drawing) provided with a second groove region in which a second groove 2b is formed and a second non-groove region 2b′ in which the second groove 2b is not formed; the second parent member 1b located on top of the first parent member 1a and including a first protrusion region in which a first protrusion 8 is formed and a first non-protrusion region 8′ in which the first protrusion 8 is not formed; and the third parent member 1c located on bottom of the first parent member 1a and including a second protrusion region in which a second protrusion 9 is formed and a second non-protrusion region 9′ in which the second protrusion 9 is not formed.

The first groove region and the first non-groove region of the first parent member 1a may be formed on the upper contact surface (in the drawing) of the first parent member 1a. The second groove region and the second non-groove region of the first parent member 1a may be formed on the lower contact surface (in the drawing) of the first parent member 1a. This is only an example, but is not limited thereto. Therefore, the positions of the contact surfaces where the first groove and non-groove regions and the second groove and non-groove regions are formed may vary.

The first and second groove regions of the first parent member 1a, the first protrusion region of the second parent member 1b, and the second protrusion region of the third parent member 1c may be located at positions corresponding to each other. In this case, the first parent member 1a may be interposed between the second and third parent members 1b and 1c, with the second parent member 1b on top and the third parent member 1c on bottom. Therefore, the first protrusion region of the second parent member 1b and the second protrusion region of the third parent member 1c may be located in an opposed relationship, with the first and second groove regions of the first parent member 1a interposed therebetween.

When at least three parent members 1 are provided and these parent members 1 are stacked on top of each other and welded by friction stir welding as in the joined component 104′ according to the modification, at least two parent members 1 (e.g., the first and second parent members 1a and 1b) may be first welded by friction stir welding, and then a remaining one of the parent members 1 (e.g., the third parent member 1c) may be welded by friction stir welding to the welded parent members 1a and 1b. In this case, at least two parent members 1a and 1b to be first welded by friction stir welding are not limited. In other words, among the at least three parent members 1, at least two parent members 1 may be first welded by friction stir welding and then a remaining one of the parent members 1 may be welded by friction stir welding to the welded parent members.

Hereinafter, it will be described as an example that the first parent member 1a and the second parent member 1b placed on top of the first parent member 1a are first welded by friction stir welding, and then the third parent member 1c is welded by friction stir welding to the welded first and second parent members 1a and 1b.

In the joined component 104′ according to the modification, friction stir welding may be performed along each contact junction formed when the second parent member 1b is fitted to the first parent member 1a. A weld zone w may be formed thereby at the contact junction, so that a plurality of weld zones w may be formed at the joined component 104′.

Then, the third parent member 1c may be placed on bottom of the first parent member 1a and friction stir welding may be performed along each contact junction. Therefore, the joined component 104′ according to the modification may have a structure in which a plurality of weld zones w is formed on each of upper and lower portions of the joined component 104′ and a hollow channel 200 is provided inside the joined component 104′ in a multi-layer structure.

In the modification, a hole 20′ may be formed while passing through a remaining region except for a unwelded interface existing in a hollow channel region 200′. In this case, only the hollow channel 200 may exist in the hollow channel region 200′ in a shape that is isolated by the weld zones w. Therefore, the hole 20′ may be formed in the remaining region except for the hollow channel region 200′ without fluidly interfering with the hollow channel 200 of the hollow channel region 200′.

The hole 20′ may be formed in a structure in which a vertical section thereof extends from a top surface to an intermediate portion of the joined component 104′, and a diagonal section thereof inclinedly extends from the intermediate portion to a bottom surface of the joined component 104′ so as not to pass through the hollow channel region 200′.

On the other hand, a hole 20′ may be formed to be inclined in a diagonal shape. In this case, in order for the hole 20′ to be formed in a structure that passes through the remaining region except for the hollow channel region 200′ and does not fluidly interfere with the hollow channel 200, the hole 20′ may be formed in a shape that passes through the parent members 1 from top to bottom in a diagonal shape.

### Fifth Embodiment

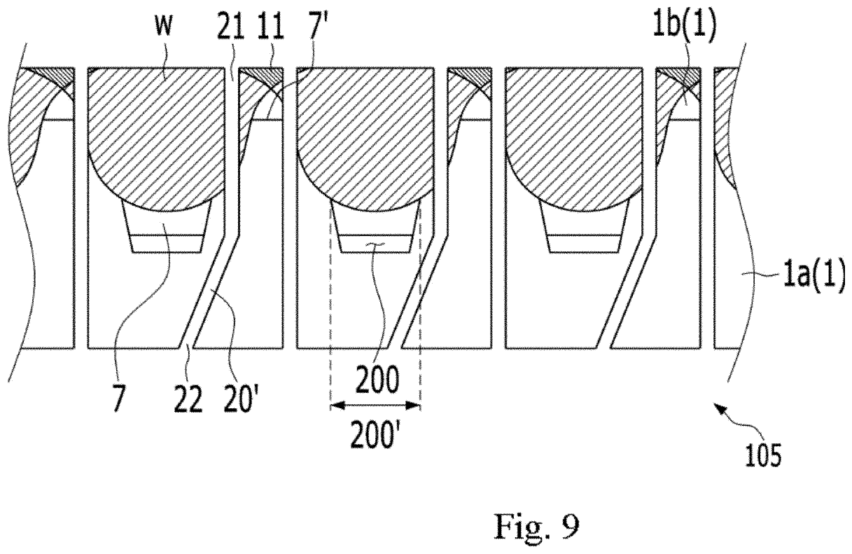

FIG. 9 is a view schematically illustrating a fifth embodiment of the present invention.

A joined component 105 according to the fifth embodiment differs from the fourth embodiment in that a weld zone w formed by friction stir welding is formed along a hollow channel 200 at a position above the hollow channel 200, and an overlap portion 11 formed by weld zones w that overlap with each other at least partially is included.

As illustrated in FIG. 9, the weld zone w formed by friction stir welding may be formed along the hollow channel 200 at a position above the hollow channel 200. In this case, the weld zone w may include a left contact junction and a right contact junction and may be formed to a position below interfaces between parent members 1. In this case, the weld zone w may be formed below the interfaces of the parent members 1 and at a depth lower than that of a protrusion 7. In other words, the weld zone w may be formed to a depth not exceeding the height of the protrusion 7 of a second parent member 1b. Therefore, when a hole 20′ is formed in a remaining region except for a unwelded interface existing in the hollow channel region 200′, the hole 20′ may be formed in a structure that is isolated from the hollow channel 200 so as not to interfere therewith.

The weld zone w may be formed larger in width than a groove 2 of a first parent member 1a and the protrusion 7 of the second parent member 1b.

The weld zone w may be formed with the width and depth as described above and may be formed to include the left and right contact junctions and at least a part of a horizontal interface between the hollow channel 200 and the hole 20′. Due thereto, a second weld zone adjacent to the periphery of a first weld zone formed on the leftmost side in FIG. 9 may overlap with at least a part of the first weld zone to form the overlap portion 11.

Each of the weld zones w includes a nugget zone, a thermo-mechanically affected zone, and a heat affected zone. Therefore, the overlap portion 11 may be formed such that the zones constituting the weld zones w overlap with each other at least partially. The overlap portion 11 may be a portion that may be formed when the interval between hollow channels 200 formed inside the joined component 105 is relatively small. Alternatively, the overlap portion 11 may be a portion that may be defined by an insertion depth when the interval between the hollow channels is relatively large but a shoulder 10a and a pin 10b of a welding tool 10 performing friction stir welding are deeply inserted to form the weld zones w.

Therefore, in the present invention, although it has been illustrated that at least a part of an interface between the parent members 1 exists below the overlap portion 11, the overlap portion 11 may be formed in a structure in which no interface exists therebelow depending on the case where the overlap portion 11 is formed.

In order for the hole 20′ to be formed in a structure that does not fluidly interfere with the hollow channel 200, the hole 20′ may be formed in a structure in which a vertical section thereof extends from a top surface to an intermediate portion of the joined component 105 and a diagonal section thereof extends from the intermediate portion to a bottom surface of the joined component 105, so that the hole 20′ passes through the parent members 1 in a combination shape of a vertical shape and a diagonal shape.

As illustrated in FIG. 9, a plurality of holes 20′ may be formed in the joined component 105. Among these, a hole 20′ formed between hollow channel regions 200′ and simultaneously passing through at least a part of the overlap portion 11, at least a part of the weld zone w, and at least a portion of the interface existing below the overlap portion 11 may exist.

In this case, in the fifth embodiment, no unwelded interface exists in each of the hollow channel regions 200′ by the weld zone w, and thus, an adverse action due to at least a part of an interface existing at an inner surface of the hole 20′ may be avoided.

In the fifth embodiment, the hole 20′ having a combination shape of a vertical shape and a diagonal shape may be formed, in which the vertical section thereof extends from the top surface to the intermediate portion of the joined component 105 and the diagonal section thereof extends from the intermediate portion to the bottom surface of the joined component 105 while avoiding interference with the hollow channel 200. Such a structure may exert an effect of efficiently forming the hollow channel 200 and the hole 20′ inside the joined component 105 while forming a regular pitch between lower openings 22 through which a process fluid is sprayed.

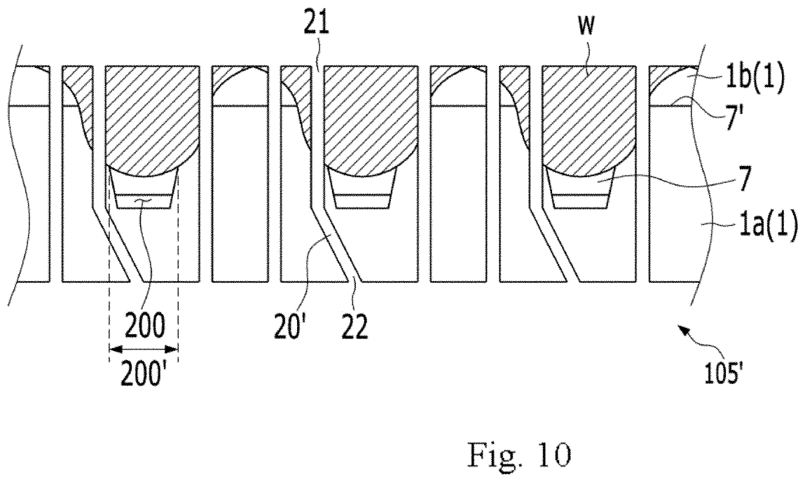

FIG. 10 is a view schematically illustrating a modification of the fifth embodiment of the present invention.

The modification of the fifth embodiment differs from the fifth embodiment in that the interval between a plurality of hollow channels 200 is relatively large, so that an overlap portion 11 is not formed.

In the modification, as in the fifth embodiment, a hole 20′ may be formed in a remaining region except for a hollow channel region 200′. In this case, the hole 20′ may be formed to pass through parent members 1 from top to bottom in a vertical shape. Alternatively, the hole 20′ may be formed to pass through parent members 1 from top to bottom in a combination shape of a vertical shape and a diagonal shape. A plurality of holes 20′ may be formed in a joined component 105′. Preferably, as illustrated in FIG. 10, a hole 20′ formed at a position adjacent to the hollow channel region 200′ may be formed in a combination shape of a vertical shape and a diagonal shape so as to be formed in a structure that does not fluidly interfere with the hollow channel region 200′.

Among the holes 20′, a hole 20′ formed through a weld zone w may exist, and a hole 20′ formed through an interface between parent members 1 existing between the hollow channel regions 200′ may exist. When the hole 20′ is formed while passing through the interface, a hole 20′ through which the same process fluid passes may be formed in the periphery of the hole 20′ passing through the interface and may be formed in a structure that is isolated from the hollow channel region 200′ by the weld zone w. Therefore, the hole 20′ passing through the interface may not adversely influence the hollow channel region 200′, and even when the process fluid moves between the holes 20′ along the interface, there is no fear of functional error because the same process fluid passes through the holes 20′.

On the other hand, a hole 20′ may be formed to pass through parent members 1 from top to bottom to be inclined in a diagonal shape. In detail, the hole 20′ formed at a position adjacent to the hollow channel region 200′ may be formed to be inclined in a diagonal shape so as to be formed in a structure that does not fluidly interfere with the hollow channel region 200′.

The holes 20′ formed in the joined component 105′ may be formed in the remaining region except for the hollow channel region 200′ in a structure in which respective lower openings 22 of the holes 20′ are arranged at a regular pitch.

### Sixth Embodiment

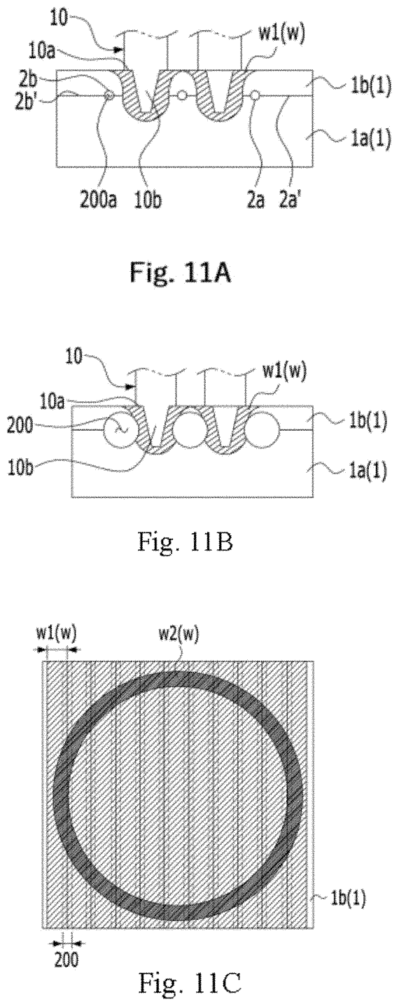

FIGS. 11A to 14B are views schematically illustrating a manufacturing process of a sixth embodiment of the present invention. The sixth embodiment differs from the first to fifth embodiments in that a communication line 50 formed inside a joined component 106 and being in communication with a hollow channel 200 is further included. In this case, in the functional aspect, the communication line 50 may perform the same function as a communication groove communicating the hollow channel 200 of each layer in the joined component 106 having a multi-layer structure, and in the structural aspect, there is a difference in that the communication line 50 is formed in a structure that communicates all the hollow channels 200 of the joined component 106 to each other at a position outside the hollow channels 200.

The joined component 106 according to the sixth embodiment may be formed in such a manner that first and second parent members 1a and 1b are welded by friction stir welding, and then a third parent member 1c is welded onto the first and second parent members 1a and 1b by friction stir welding. Although three parent members 1 are stacked on top of each other and welded by friction stir welding, this is only an example. Therefore, the number of the parent members 1 is not limited thereto.

Hereinafter, the sixth embodiment will be described in detail with reference to FIGS. 11A to 14B.

As illustrated in FIGS. 11A to 11C, in the joined component 106 according to the sixth embodiment, the hollow channel 200 may be formed therein through a process of providing the hollow channel 200.

As illustrated in FIG. 11A, at least two parent members 1 in which a groove is formed in at least one of opposed contact surfaces thereof may be welded by friction stir welding. As an example, the at least two parent members 1 in which the groove is formed may be comprised of the first and second parent members 1a and 1b. In this case, a parent member located on the lower side in FIG. 11A may be the first parent member 1a, and a parent member stacked on top of the first parent member 1a may be the second parent member 1b.

In the sixth embodiment, the first parent member 1a in which a first groove 2a is formed and the second parent member 1b in which a second groove 2b is formed may be provided.

The first parent member 1a in which the first groove 2a is formed and the second parent member 1b in which the second groove 2b is formed are located such that the first and second grooves 2a and 2b are opposed to each other, and a first non-groove region and a second non-groove region opposed to each other are welded by first friction stir welding.

The first friction stir welding may be performed along a contact junction formed on at least a part of each interface between the parent members 1 to weld the first non-groove region and the second non-groove region. A weld zone formed by the first friction stir welding may be a first weld zone w1.

As illustrated in FIG. 11A, the first and second parent members 1a and 1b may be welded by friction stir welding to form the first weld zone w1, and a hollow 200a having a circular cross-section may be formed by the first groove 2a and the second groove 2b.

Then, as illustrated in FIG. 11B, a process of performing boring on the hollow 200a to form the hollow channel 200 may be performed. The boring of the hollow 200a may be performed by wire cut electric discharge machining or chemical etching.

The hollow 200a may be enlarged by boring. At least a part of the first weld zone w1 formed in the periphery of the hollow 200a may be removed during the process of enlarging the hollow 200a by boring. Therefore, the hollow channel 200 may be formed in a shape removing at least a part of the first weld zone w1.

The hollow channel 200 may be formed by using the hollow 200a of an original shape, or by enlarging the hollow 200a by boring.

The hollow channel 200 formed while removing at least a part of the first weld zone w1 may have a shape in which no interface between the parent members 1 exists at an inner surface thereof. This can block obstacles such as particles that may be introduced into the hollow channel 200 along the interface.

The inner surface of the hollow channel 200 may be anodized or plated. This may be a process for preventing corrosion of the inner surface of the hollow channel 200.

As illustrated in FIG. 11C, second friction stir welding may be performed on an upper surface of the joined component 106 in which hollow channel 200 is formed. The second friction stir welding may be performed in a shape of a circular closed curve which closes at least one end of the hollow channel 200 formed inside the joined component 106 in which the first and second parent members 1a and 1b are joined. By the second friction stir welding, an outer peripheral region which closes the at least one end of the hollow channel 200 may be formed. The outer peripheral region formed by the second friction stir welding may be a second weld zone w2 as one weld zone.

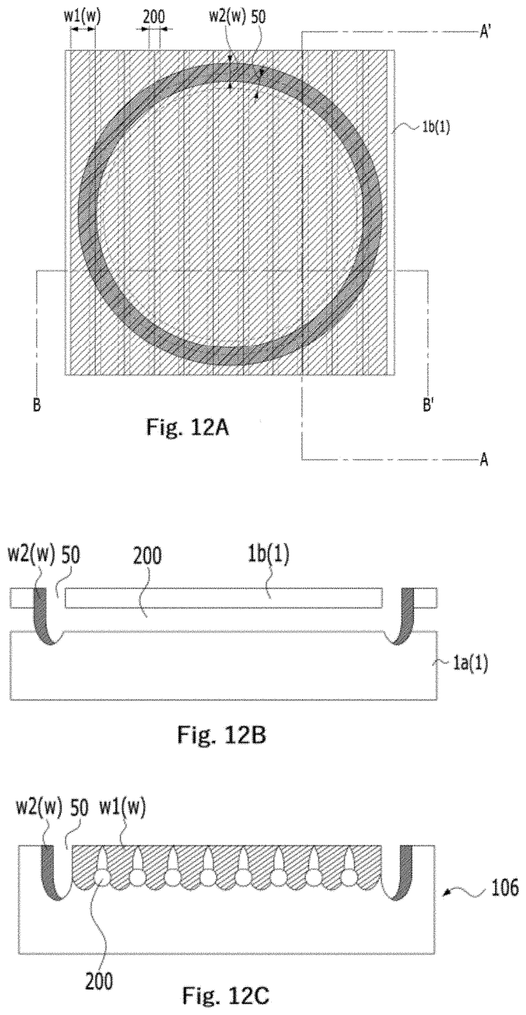

Then, as illustrated in FIG. 12A, grooving is performed in the region inside the outer peripheral region along the outer peripheral region formed by the second friction stir welding. Grooving may be performed to a depth deeper than the depth in which the hollow channel 200 of the joined component 106 is formed, thereby forming inside the joined component 106 the communication line 50 in communication with the hollow channel 200. In the case of the communication line 50, the depth of the communication line 50 is not limited as long as it is possible for the communication line 50 to be in communication with the hollow channel 200 inside the joined component 106.

FIG. 12B is a view illustrating a sectional surface cut along line A-A′ of FIG. 12A. As illustrated in FIG. 12B, grooving is performed in the region inside the outer peripheral region formed by the second friction stir welding to form the communication line 50. The communication line 50 may be formed to be in communication with the hollow channel 200 to allow the hollow channel 200 to be in communication with the communication line 50 inside the joined component 106 at opposite ends thereof.

An inner surface of the communication line 50 may be anodized or plated. This may be a process for preventing corrosion of the inner surface of the communication line 50.

Since the communication line 50 is formed by performing grooving in the region inside the outer peripheral region, a weld zone formed by friction stir welding may exist outside the communication line 50. In detail, at least a part of the second weld zone w2 formed by the second friction stir welding may exist outside the communication line 50.

FIG. 12C is a view illustrating a sectional surface cut along line B-B′ of FIG. 12A. As illustrated in FIG. 12C, an inside of the joined component 106 in which the communication line 50 and the hollow channel 200 are formed may have a shape in which a plurality of hollow channels 200 and a plurality of weld zones w are formed inside the communication line 50.

The weld zones w formed inside the communication line 50 are first weld zones w1 formed by the first friction stir welding and may serve to isolate holes 20′ and the hollow channels 20 inside the joined component 106.

Further, each of the hollow channels 200 may have a shape removing at least a part of each of the weld zones w, and may have a shape in which at least a part of the weld zone w is formed in the periphery of the hollow channel 200. Since the hollow channel 200 may be formed while removing at least a part of the weld zone w, no horizontal interface between the parent members 1 exists at the inner surface thereof. Therefore, when the joined component 106 is used in a semiconductor or display manufacturing process, a temperature control medium that is provided in the hollow channel 200 may not be adversely influenced by obstacles introduced along the interface. Therefore, it is possible to ensure uniformity of internal temperature of the joined component 106, resulting in minimized deformation of a product, and thus the joined component 106 can function more effectively.

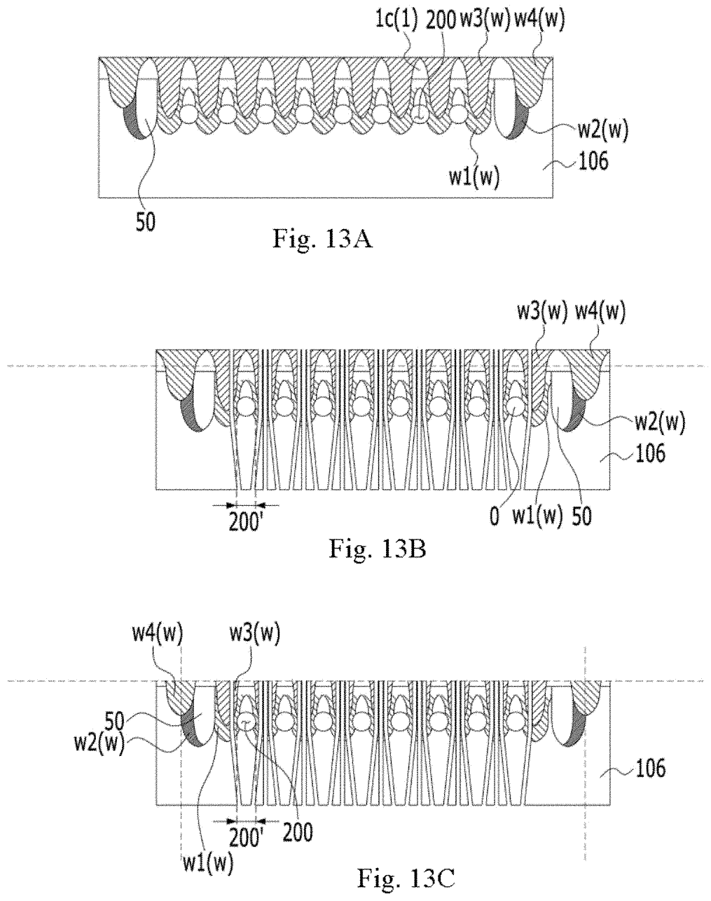

Then, as illustrated in FIG. 13A, the third parent member 1c may be stacked on an upper surface of the joined component 106 in which the hollow channels 200 and the communication line 50 are formed. The joined component 106 in which the first and second parent members 1a and 1b are joined and the hollow channels 200 and the communication line 50 are formed may have a shape in which an opening is formed in an upper surface of the communication line 50. In other words, the communication line 50 before the third parent member 1c is joined may have a shape having an open upper surface.

When the upper surface of the communication line 50 is open, the temperature control medium provided in the hollow channels 200 may not be able to properly perform a function thereof. Accordingly, in order to close the open upper surface of the communication line 50, the third parent member 1c may be stacked on the joined component 106 in which the first and second parent members 1a and 1b are joined.

As illustrated in FIG. 13A, the third parent member 1c may be stacked on the joined component 106 in which the communication line 50 and the hollow channels 200 are formed, and then third friction stir welding may be performed.

The third friction stir welding may be performed along at least a part of an interface between the joined component 106, in which the first and second parent members 1a and 1b are joined and the hollow channels 200 and the communication line 50 are formed, and the third parent member 1c.

The at least a part of the interface between the joined component 106, in which the first and second parent members 1a and 1b are joined and the hollow channels 200 and the communication line 50 are formed, and the third parent member 1c is a region where each contact junction is formed, and the third friction stir welding is performed along the contact junction to form a weld zone. The weld zone formed by the third friction stir welding may be a third weld zone w3.

Third weld zones w3 may be formed at the respective contact junctions between the joined component 106, in which the first and second parent members 1a and 1b are joined and the hollow channels 200 and the communication line 50 are formed, and the third parent member 1c at positions corresponding to the first weld zones w1, or may be formed at contact junctions not corresponding to the first weld zones w1.

As illustrated in FIG. 13A, after the third weld zones w3 are formed, opposite end portions (in FIG. 13A) of the joined component 106 may be welded by the third friction stir welding, or may be welded by a fourth friction stir welding. In the sixth embodiment, the opposite end portions (in FIG. 13A) of the joined component 106 are welded by the fourth friction stir welding, and weld zones are formed thereby at the opposite end portions of the joined component 106. The weld zones formed by the fourth friction stir welding may be fourth weld zones w4. Therefore, a joined component 106 in which the first, second, and third parent members 1a, 1b, and 1c are joined from bottom to top is obtained.

Due to the fourth weld zones w4 formed at the opposite end portions (in FIG. 13A) of the joined component 106, among horizontal interfaces between the joined component 106, in which the hollow channels 200 and the communication line 50 are formed, and the third parent member 1c, horizontal interfaces existing at outer peripheral portions of the joined component 106 may be removed.

In detail, a contact junction may be formed at each of horizontal interfaces between an upper surface of the second weld zone w2 formed outside the communication line 50 and the third parent member 1c. The fourth friction stir welding may be performed along the respective contact junctions to form the fourth weld zones w4, thereby removing the interfaces horizontally existing at the outer peripheral portions of the joined component 106.

This can prevent the problem that when a fluid is provided as the temperature control medium, the fluid flowing through the communication line 50 moves along the interfaces horizontally existing at the outer peripheral portions of the joined component 106, or corrodes the interfaces to cause an adverse action from occurring.

Then, as illustrated in FIG. 13B, a process of planarizing the third weld zones w3 and the fourth weld zones w4 of the joined component 106 may be performed. At least a part of each of the weld zones w3 and w4 may be planarized. In this case, at least a part of each of the third and fourth weld zones w3 and w4 existing from the inside of the joined component 106 to the upper surface may be planarized, except for the first and second weld zones w1 and w2 existing inside the joined component 106.

As shown in FIG. 13B, planarizing may be performed at a position, indicated by a dotted line, above the contact junctions formed at the interfaces between the joined component 100, in which the hollow channels 200 and the communication line 50 are formed, and the third parent member 1c.

The planarizing may be a process that is performed in the same manner in the first to fifth embodiments, and is a process that may be selectively performed.

Then, a hole 20′ passing through the first and third weld zones w1 and w3 and the parent members 1 from top to bottom may be formed. The hole 20′ may be formed in a remaining region except for a unwelded interface existing in a hollow channel region 200′ to form a structure that avoids interference with the hollow channel 200.

A plurality of holes 20′ may be formed in the joined component 106. In detail, in FIG. 13B, a hole 20′ formed at a position adjacent to the hollow channel region 200′ may be formed in a structure that is isolated from the hollow channel region 200′ by the weld zones w. The hole 20′ may be formed in a combination shape of a vertical shape and a diagonal shape, in which a vertical section thereof extends from a top surface to an intermediate portion of the joined component 106 and a diagonal section thereof extends from the intermediate portion to a bottom surface of the joined component 106.

Due to such a shape, the holes 20′ may be formed in a structure in which respective lower openings 22 of the holes 20′ are uniformly formed at a regular pitch and the holes 20′ avoid interference with the hollow channel 200.

Then, as illustrated in FIG. 13C, a process of forming an outer periphery of the joined component 106 may be performed. This process may be selectively performed. For example, when the joined component 106 is provided in semiconductor manufacturing process equipment or display manufacturing process equipment 1000, the joined component 106 may be provided in a shape having a circular cross-section. In order to form the joined component 106 into a shape having a circular cross-section, the process of forming the outer periphery of the joined component 106 as illustrated in FIG. 13C may be performed.

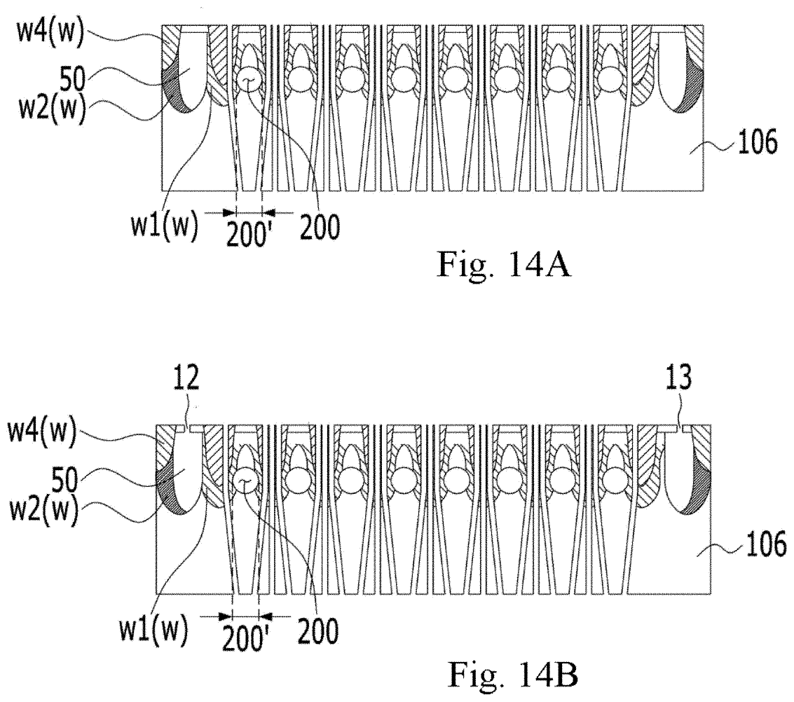

FIG. 14A is a view illustrating the joined component 106 after forming of the outer periphery is performed.

When the temperature control medium provided in the hollow channels 200 is the fluid, the joined component 106 may include an injection port 12 through which the fluid is injected into the hollow channels 200, and a discharge port 13 through which the fluid flowing inside the joined component 106 is discharged.

When the temperature control medium is a heating wire, the injection port 12 and the discharge port 13 may function as an injection port and a discharge port through which the heating wire is introduced into and withdrawn from the joined component 106.

The injection port 12 and the discharge port 13 may be formed to be in communication with the communication line 50. The communication line 50 is formed to be in communication with the hollow channels 200. Therefore, the injection port 12 and the discharge port 13 may be formed to be in communication with the communication line 50, thereby having a structure in communication with the hollow channels 200.

In the present invention, as an example, the injection port 12 and the discharge port 13 may be formed to pass through the third parent member 1c from top to bottom at one and the other ends of the third parent member 1c and to be in communication with the communication line 50. This may be implemented in a shape as illustrated in FIG. 14B. As an example, the injection port 12 may be formed at one end (the left side in FIG. 14B) of the third parent member 1c, and the discharge port 13 may be formed at the other end (the right side in FIG. 14B) of the third parent member 1c.

In the sixth embodiment, as illustrated in FIG. 14B, although it is illustrated that the injection port 12 and the discharge port 13 are formed to pass through the third parent member 1c from top to bottom and to be in communication with the communication line 50, this is only an example. Accordingly, the positions where the injection port 12 and the discharge port 13 are formed are not limited thereto.

Further, one end and the other end of the third parent member 1c, where the injection port 12 and the discharge port 13 are formed, are not limited to a specific position. However, the injection port 12 and the discharge port 13 may be formed to pass through the third parent member 1c from top to bottom and to be in communication with the communication line 50 at positions opposite to each other with the hollow channels 200 interposed therebetween.

In the sixth embodiment referring to FIGS. 11A to 14B, although it is illustrated that the hole 20′ is formed in a combination shape of a vertical shape and a diagonal shape, the hole 20′ may be formed in a shape that passes through the parent members 1 to be inclined in a diagonal shape. In this case, preferably, a hole 20′ formed at a position adjacent to the hollow channel region 200′ is formed to be inclined in a diagonal shape, and a remaining hole 20′ formed at a position other than the above position is formed in a vertical shape or in a combination shape of a vertical shape and a diagonal shape.

In the case of placing an emphasis on the aspect of temperature control, as in the first to sixth embodiments, the joined component 106 according to the present invention may be provided with the temperature control medium in the hollow channel 200.

On the other hand, the joined component 106 according to the present invention may be formed in a structure capable of performing a function of spraying different process fluids with an emphasis on the aspect of spraying of the different process fluids. In this case, the joined component 106 may be a joined component 106 in which at least two parent members 1 are welded by friction stir welding, and may include: a first fluid hole 20 passing through the parent members 1 from top to bottom and through which a first process fluid passes, and a second fluid hole 30 being in communication with a first hollow channel 201 formed inside the joined component 106, and through which a second process fluid passes. In the joined component 106, a weld zone w formed by the friction stir welding may remove at least a part of an interface between the first fluid hole 20 and the second fluid hole 30, and the first fluid hole 20 may be formed in a structure that passes through a remaining region except for a unwelded interface existing in the first hollow channel region 201′ including the first hollow channel 201.

When the joined component 106 is formed in a structure that emphasizes the aspect of spraying of different process fluids with such a configuration, the hollow channel 200 including the temperature control medium therein may function as a configuration for forming the second fluid hole 30 through which the second process fluid passes.

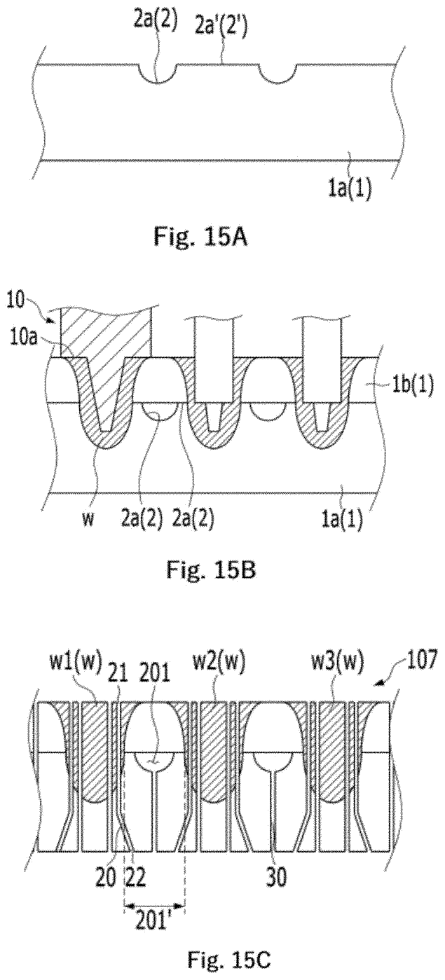

Hereinafter, embodiments of joined components 106 that emphasize the aspect of spraying of different process fluids will be described in detail with reference to FIGS. 15A to 20. The joined components 106 according to the following embodiments differ from the joined components according the first to sixth embodiments in that a hole through which a process fluid different from the process fluid passing through the hole 20′ is additionally provided. Other configurations remain the same as those of the first to sixth embodiments, and thus a detailed description thereof will be omitted.

### Seventh Embodiment

FIGS. 15A, 15B, and 15C are views schematically illustrating a manufacturing process of a seventh embodiment of the present invention.

A joined component 107 according to the seventh embodiment includes a first hollow channel 201, a first fluid hole 20 through which a first process fluid passes, and a second fluid hole 30 through which a second process fluid passes.

Processes of FIGS. 15A and 15B may be performed in the same manner as the processes of FIGS. 2A and 2B of the first embodiment referring to FIGS. 2A, 2B, and 2C. These may be performed in such a manner that as illustrated in FIG. 15A, a first parent member 1a in which a first groove 2a is formed is placed, and then as illustrated in FIG. 15B, a second parent member 1b is stacked on top of the first parent member 1a and friction stir welding is performed along a contact junction to form a weld zone w.

Then, as illustrated in FIG. 15C, a process of forming the first fluid hole 20 and the second fluid hole 30 may be performed.

First, the first fluid hole 20 may be formed to pass through a remaining region except for a unwelded interface existing in a first hollow channel region 201′ including a first hollow channel 201. In this case, the first fluid hole 20 may be formed in a structure isolated from the first hollow channel region 201′ by the weld zone w. In other words, a shape in which no interfaces that communicates the respective configurations to each other exist therebetween by the weld zone w may be formed.

As illustrated in FIG. 15C, the first fluid hole 20 may pass through the parent members 1 from top to bottom and may be configured such that upper and lower portions of the first fluid hole 20 are not located on the same vertical line but are located eccentrically with respect to each other. This may be a shape implemented by forming a structure that avoids fluid interference with the first hollow channel region 201′.

As illustrated in FIG. 15C, at least a part of the first fluid hole 20 may be formed to be inclined in a diagonal shape, and at least a part thereof may be formed in a vertical shape. In other words, the first fluid hole 20 may be formed in a combination shape of a vertical shape and a diagonal shape. In this case, the shape of the first fluid hole 20 is not limited to thereto, and may be formed in a vertical shape or a diagonal shape depending on the position formed inside the joined component 107.

As illustrated in FIG. 15C, a lower section of the first fluid hole 20 located at a lower portion of the joined component 107 may be formed in a diagonal shape or a vertical shape. A plurality of first fluid holes 20 may be formed in the joined component 107. Among respective lower sections of the first fluid holes 20, a lower section a first fluid hole 20 located a lower portion the first hollow channel region 201′ may be formed in a diagonal shape to form a structure that avoids fluid interference with the first hollow channel 201 of the first hollow channel region 201′.

In this case, a lower opening 22 of the first fluid hole 20 located at the lower portion of the joined component 107 may be formed within the range of a vertical projection region of an interface of the parent members 1.

The first fluid hole 20 may be formed in a remaining region except for a unwelded interface existing in the first hollow channel region 201′. In this case, preferably, at least a part of a first fluid hole 20 formed at a position adjacent to the first hollow channel region 201′ may be formed inclined in a diagonal shape to form a structure that avoids fluid interference with the first hollow channel 201. Therefore, the first fluid hole 20 may be formed to pass through the parent members 1 from top to bottom in a combination shape of a vertical shape and a diagonal shape in which a vertical section of the first fluid hole 20 extends from a top surface to an intermediate portion of the joined component 107, and a diagonal section of the first fluid hole 20 extends from the intermediate portion to a bottom surface of the joined component 107.

A remaining first fluid hole 20 except for the first fluid hole 20 formed at the above position may be formed in a vertical shape, a combination shape of a vertical shape and a diagonal shape, or a diagonal shape.

However, when the joined component 107 is provided in the semiconductor manufacturing process equipment or display manufacturing process equipment 1000, it may be important to uniformly spray different process fluids onto a spray target when the joined component 107 has a function of spraying the different process fluids.

Therefore, respective lower openings 22 of the first and second fluid holes 20 and 30 through which different process fluids are sprayed should be arranged at a regular pitch. In consideration of this, when the first fluid hole 20 is formed at a position other than a position adjacent to the first hollow channel region 201′, the first fluid hole 20 may be formed in a suitable shape e.g., a vertical shape, a combination shape of a vertical shape and a diagonal shape, or a diagonal shape.

As illustrated in FIG. 15C, in the seventh embodiment, the second fluid hole 30 being in communication with the first hollow channel region 201′ may be formed. The second fluid hole 30 may be formed in a shape that passes through the lower portion of the joined component 107.

The second fluid hole 30 may be a fluid hole formed in communication with the first hollow channel region 201′ to exist in the first hollow channel region 201′. Therefore, the second fluid hole 30 may be formed in a structure that is isolated from the first fluid hole 20 by the weld zone w.

A plurality of second fluid holes 30 may be formed in the joined component 107. In order for the joined component 107 to uniformly spray different process fluids onto the spray target, the first fluid holes 20 and the second fluid holes 30 located at the lower portion of the joined component 107 may be arranged at a regular pitch to allow the different process fluids to be sprayed therethrough.

In this case, in FIG. 15C, it is illustrated that each of the second fluid holes 30 is formed at a center line vertically disposed on a plane of the first hollow channel 201, but the present invention is not limited thereto. For example, depending on the pitch between the lower openings 22 of the first fluid holes 20 and the pitch between the lower openings 22 of the second fluid holes 30, the second fluid hole 30 may be formed to be in communication with the first hollow channel 201 at a position other than the above position and in a diagonal shape. In other words, the positions of the second fluid holes 30 are not limited as long as the second fluid holes 30 are formed at positions where each of the second fluid holes 30 is in communication with the first hollow channel 201 and the lower openings 22 thereof are arranged at a regular pitch.

In the seventh embodiment, among first fluid holes 20 formed in a remaining region except for the hollow channel region 201′ in FIG. 15C, a plurality of fluid holes 20 formed in each weld zone w may be formed to be symmetrical to each other with respect to a center line vertically disposed on a plane of the first hollow channel region 201′.

The seventh embodiment remains the same as the first embodiment referring to FIGS. 2A and 2B in all configurations and structures except for the structure in which the second fluid hole 30 being in communication with the first hollow channel region 201′ is formed. Therefore, a detailed description of the shape in which the first fluid holes 20 are formed in a symmetrical shape will be omitted with reference to the description of the first embodiment.

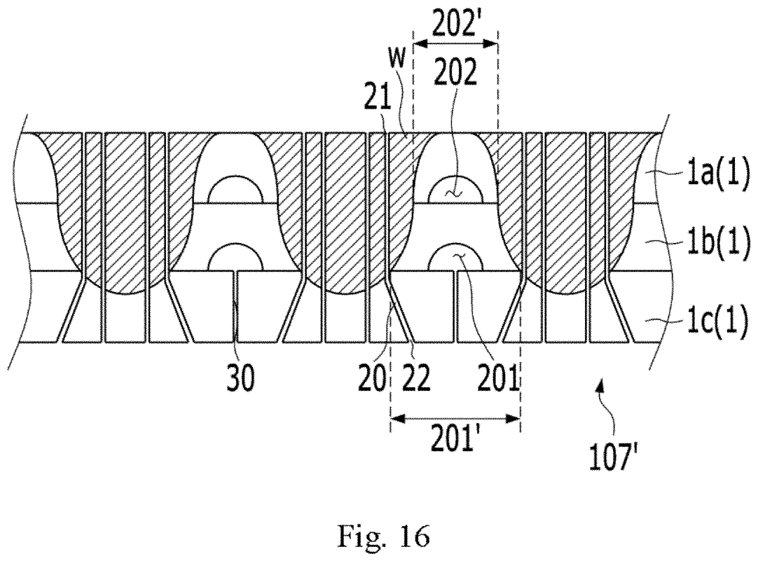

FIG. 16 is a view schematically illustrating a modification of the seventh embodiment of the present invention.

The modification of the seventh embodiment differs from the seventh embodiment in that a second hollow channel 202 formed inside a joined component 107′ and including a temperature control medium therein is further included.

The modification of the seventh embodiment remains the same in all configurations as the embodiment in which the hollow channel 20 has a multi-layer structure, which is described with reference to FIG. 5A, except that a second fluid hole 30 is formed. Referring to FIG. 5A again, as an example, a hollow channel 200 formed by a second groove 2b of a second parent member 1b may be a first hollow channel 201, and a hollow channel 200 formed by a first groove 2a of a first parent member 1a may be a second hollow channel 202.

Therefore, a detailed description of a process of manufacturing the joined component 107′ according to the modification of the seventh embodiment will be omitted, and description will be mainly given in terms of characteristic components with reference to FIG. 16.

In the modification of the seventh embodiment, as in the seventh embodiment, first and second fluid holes 20 and 30 may be arranged at a regular pitch to allow different process fluids to be uniformly sprayed therethrough.

The joined component 107′ according to the modification of the seventh embodiment may not only perform a function of spraying different process fluids through the first and second fluid holes 20 and 30, but also ensuring uniformity of product temperature by inclusion of the temperature control medium in the second hollow channel 202.

The temperature control medium may be a fluid or a heating wire. Alternatively, the temperature control medium may be a heating or cooling medium.

As illustrated in FIG. 16, in the modification, the second hollow channel 202 may be formed inside the joined component 107′. In this case, the first fluid hole 20 may be formed in a remaining region except for non-welded interfaces existing in a second hollow channel region 202′. Therefore, the second hollow channel 202 may be formed in a structure that is isolated from the first fluid hole 20 by a weld zone w.

The first hollow channel 201 may be formed on a different layer from the second hollow channel 202. Therefore, the first hollow channel 201 and the second fluid hole 30 being communication with the first hollow channel 201 may not adversely influence the second hollow channel 202.

Therefore, it is possible to block an adverse action which may occur in the temperature control medium provided in the second hollow channel 202 along interfaces.

On the other hand, as in the embodiment referring to FIG. 5B, a first fluid hole 20 may be formed to pass through parent members 1 from top to bottom to be inclined in a diagonal shape.

### Eighth Embodiment

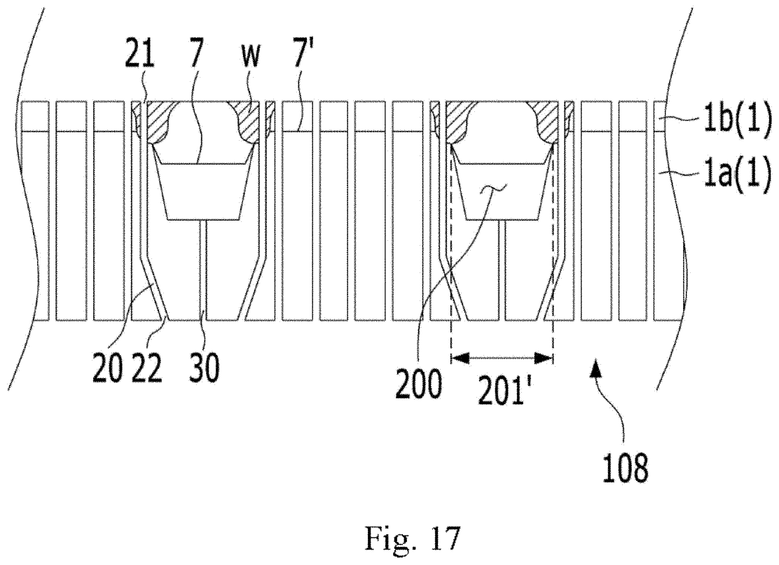

FIG. 17 is a view schematically illustrating an eighth embodiment of the present invention.

A joined component 108 according to the eighth embodiment differs from the seventh embodiment in that parent members 1 are formed in shapes capable of fitting together. The eighth embodiment differs from the third embodiment referring to FIGS. 6A, 6B, and 6C in that a second fluid hole 30 is formed. Other configurations and structures remain the same as those of the third embodiment, and thus a detailed description thereof will be omitted.

As illustrated in FIG. 17, the second fluid hole 30 may be formed in the first hollow channel 201 to be in communication therewith.

Due to such a structure, a joined component 108 according to the eighth embodiment may perform a function of spraying different process fluids through respective fluid holes 20 and 30.

As illustrated in FIG. 17, in the eighth embodiment, the first fluid hole 20 may be formed to pass through parent members 1 from top to bottom in a combination shape of a vertical shape and a diagonal shape, or in a diagonal shape. However, the first fluid hole 20 may be formed in a remaining region except for a first hollow channel region 201′.

### Ninth Embodiment

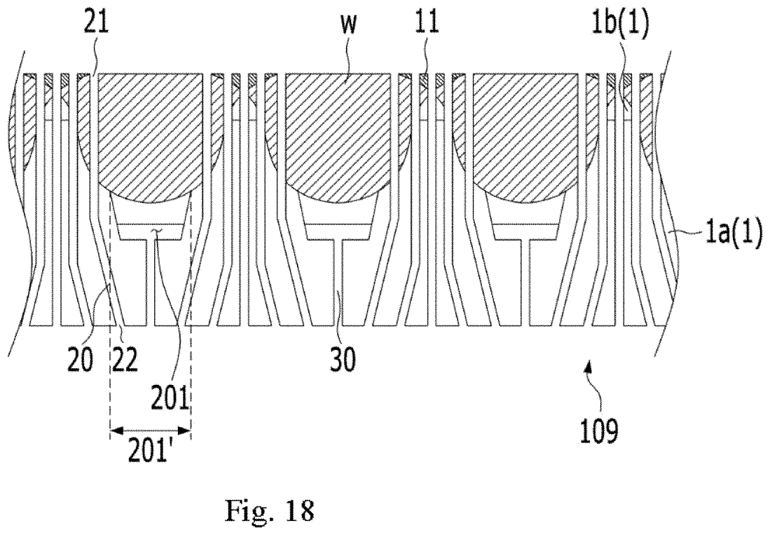

FIG. 18 is a view schematically illustrating a ninth embodiment of the present invention.

A joined component 109 according to the ninth embodiment differs from the seventh embodiment in that friction stir welding is performed along a first hollow channel 201 at a position above the first hollow channel 201, and an overlap portion 11 formed by weld zones w that overlap with each other at least partially is included.

In other words, the joined component 109 according to the ninth embodiment may include parent members 1 having shapes capable of fitting together. In the ninth embodiment, the joined component 109 may further include the overlap portion 11 formed by the weld zones w that overlap with each other at least partially, the weld zones 2 being formed by friction stir welding along the first hollow channel 201 at a position thereabove.

The ninth embodiment remains the same in configuration and structure as the fifth embodiment described with reference to FIG. 9, except that the second fluid hole 30 being in communication with the first hollow channel 201 is formed, and a detailed description thereof will be omitted. However, as an example, there is a difference in that the shape in which first fluid holes 20 are symmetrically formed with respect to a center line vertically disposed on a plane of a first hollow channel region 201′ is different. This is only a difference in illustrated shape, but it is common in that holes through which a process fluid passes are formed in a symmetrical shape with respect to a center line vertically disposed on a plane of a hollow channel region.

As illustrated in FIG. 18, in the ninth embodiment, the first fluid hole 20 may be formed to pass through parent members 1 from top to bottom in a combination shape of a vertical shape and a diagonal shape, or in a diagonal shape. However, the first fluid hole 20 may be formed in a remaining region except for a first hollow channel region 201′.

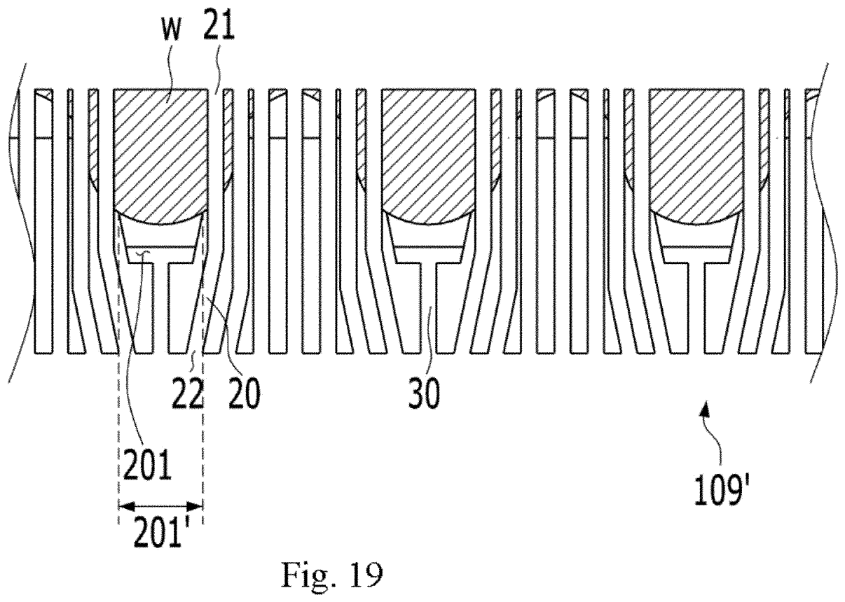

FIG. 19 is a view schematically illustrating a modification of the ninth embodiment of the present invention.

The modification of the ninth embodiment as illustrated in FIG. 19 differs from the modification of the fifth embodiment described with reference to FIG. 10 in that first fluid holes 20 are symmetrically formed with respect to a center line vertically disposed on a plane of a first hollow channel region 201′ and a second fluid hole 30 is formed. Other configurations and structures remain the same as those of the modification of the fifth embodiment.

As illustrated in FIG. 19, in the modification, a first fluid hole 20 may be formed to pass through parent members 1 from top to bottom in a combination shape of a vertical shape and a diagonal shape, or in a diagonal shape. However, the first fluid hole 20 may be formed in a remaining region except for the first hollow channel region 201′ to form a structure that avoids interference with the first hollow channel region 201′.

### Tenth Embodiment

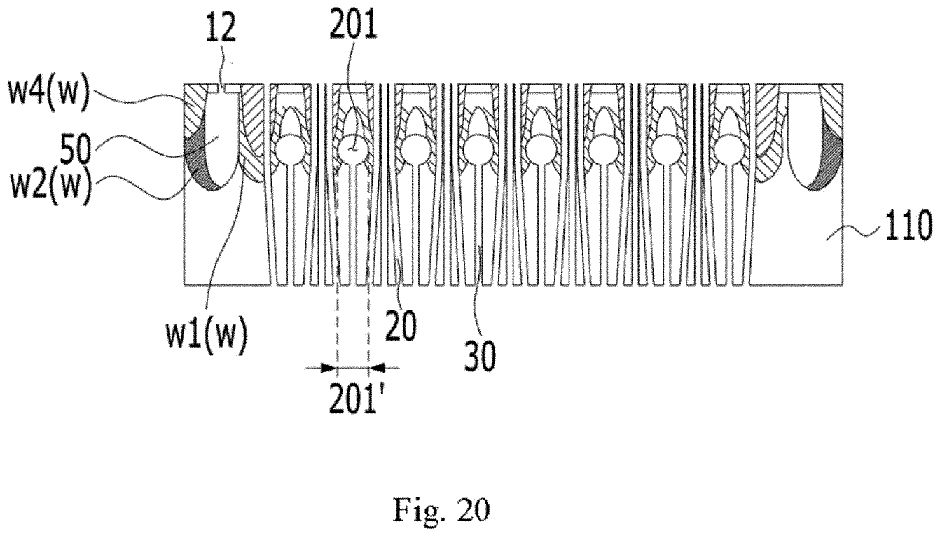

FIG. 20 is a view schematically illustrating a tenth embodiment of the present invention.

The tenth embodiment differs from the seventh embodiment in that a communication line 50 formed inside a joined component 110 and being in communication with a first hollow channel 201 is included.

The tenth embodiment as illustrated in FIG. 20 differs from the sixth embodiment described with reference to FIGS. 11A, 11B, and 11C in that a second fluid hole 30 being in communication with the first hollow channel 201 is formed. Other configurations and structures remain the same as those of the sixth embodiment. Therefore, description will be mainly given in terms of characteristic components.

As illustrated in FIG. 20, the second fluid hole 30 may be formed to be in communication with the first hollow channel 201. In this case, since the joined component 110 according to the tenth embodiment includes the communication line 50 being in communication with the first hollow channel 201, the second fluid hole 30 may have a structure that is in communication with the communication line 50.

Therefore, in the tenth embodiment, a second process fluid may be injected through an injection port 12 and sprayed through the second fluid hole 30 via the communication line 50. When the joined component 110 includes a fluid as a temperature control medium and performs a function that emphasizes the aspect of temperature control, in the sixth embodiment, the injection port 12 and the discharge port 13 for allowing the fluid to be injected into and discharged from the communication line 50 12 are provided. However, in the tenth embodiment, the joined component 110 performs a function that emphasizes the aspect of spraying of different process fluids. Therefore, only an injection port 12 may be provided to allow the second process fluid to be introduced into the first hollow channel 201 through the communication line 50. The injection port 12 may be formed to be in communication with the communication line 50 and may be formed to pass through an outer peripheral region of a second parent member 1b or the joined component 110.

As in the seventh to tenth embodiments, the joined component 110 according to the present invention may provide a structure in which first and second fluid holes 20 and 30 are not in communication with each other so that first and second process fluids are separately injected into the joined component 110 and do not mix with each other inside the joined component 110. In this case, the first fluid hole 20 may be formed to pass through parent members 1 from to bottom in a combination shape of a vertical shape and a diagonal shape or in a diagonal shape to form a structure that avoids interference with the first hollow channel 201 being in communication with the second fluid hole 30. Due to such a structure, it is possible to prevent the problem that different process fluids may react with each other inside the joined component 110 before spraying through the respective fluid holes, causing undesired chemical reaction to occur. In other words, due to such a structure, the joined component 110 having a structure that emphasizes the aspect of spraying of different process fluids has an effect of preventing the different process fluids from chemically reacting with each other inside the joined component 110 before spraying.

When the joined component 110 is formed in a structure that emphasizes the aspect of spraying of different process fluids as in the seventh to tenth embodiments, the joined component 110 may perform a more effective process in thin film formation in a semiconductor or display manufacturing process.

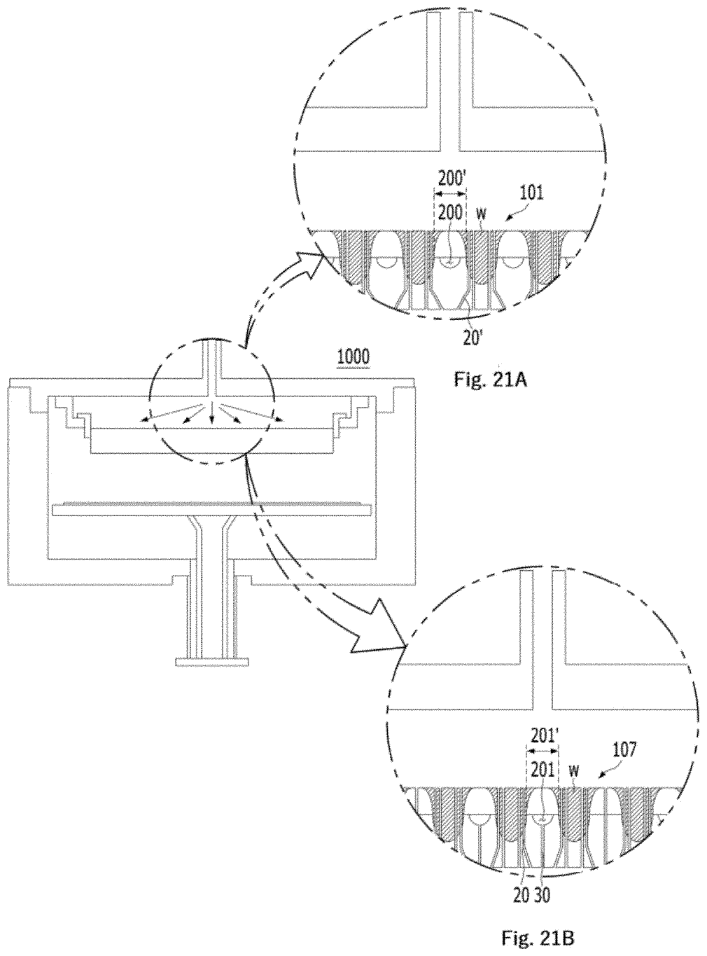

The joined components according to the embodiments and the modifications of the present invention may be provided in semiconductor manufacturing process equipment or display manufacturing process equipment. FIGS. 21A and 21B are views schematically illustrating semiconductor manufacturing process equipment or display manufacturing process equipment 1000 including the joined components according to the embodiments of the present invention.

The semiconductor manufacturing process equipment or display manufacturing process equipment includes etching equipment, cleaning equipment, heat treatment equipment, ion implantation equipment, sputtering equipment, CVD equipment, or the like which will be described below. Therefore, the joined components according to the present invention may be joined components provided in etching equipment, cleaning equipment, heat treatment equipment, ion implantation equipment, sputtering equipment, or CVD equipment.

FIG. 21A is a view illustrating the joined component 101 according to the first embodiment as an example among the joined components formed with a structure that emphasizes the aspect of temperature control, in which a part of the joined component 101 is illustrated enlarged. FIG. 21B is a view illustrating the joined component 107 according to the seventh embodiment as an example among the joined components formed with a structure that emphasizes the aspect of spraying of different process fluids, in which a part of the joined component 107 is illustrated enlarged.

The joined components provided in the semiconductor manufacturing process equipment or display manufacturing process equipment 1000 are not limited to the first and seventh embodiments, and may formed in a suitable structure for each aspect and provided in the semiconductor or display manufacturing process equipment.

First, the semiconductor manufacturing process equipment or display manufacturing process equipment 1000 including a joined component with a structure that emphasizes the aspect of temperature control will be described with reference to FIG. 21A. In the description referring to FIG. 21A in which the joined component 101 according to the first embodiment is illustrated as an example, the same reference numerals as those of the joined component 101 according to the first embodiment will be given to the joined component.

The semiconductor manufacturing process equipment or display manufacturing process equipment including the joined component 101 may be etching equipment. The joined component 101 may be a joined component 101 for supplying a process fluid for an etching process to a workpiece. The process fluid passes through the hole 20′. The etching equipment may be used to pattern a portion on a wafer or glass using the process fluid passing through the hole 20′ of the joined component 101. The etching equipment may be wet etching equipment, dry etching equipment, plasma etching equipment, or reactive ion etching (RIE) equipment.

When the joined component 101 is provided in the etching equipment, uniformity of product temperature may be ensured by a temperature control medium provided in a hollow channel 200. Therefore, it is possible to minimize deformation of a product. Further, an interface between the hollow channel 200 and the hole 20′ is removed by a weld zone w formed between the hollow channel 200 and the hole 20′, and thus no interface exists between the hollow channel 200 and the hole 20′. Due to such a structure, it is possible to prevent the hollow channel 200 and the hole 20′ from adversely influencing each other in their functions, and to reduce incidence of disturbance factors that may cause functional errors in the product.

The semiconductor manufacturing process equipment of display manufacturing process equipment including the joined component 101 may be cleaning equipment. The joined component 101 may be a joined component 101 for supplying a process fluid for a cleaning process to a workpiece. The process fluid passes through the hole 20′. The cleaning equipment may be used to clean particulate or chemical foreign substances that may cause defects in a manufacturing process, using the process fluid passing through the hole 20′ of the joined component 101. The cleaning equipment may be a cleaner or a wafer scrubber.

When the joined component 101 is provided in the cleaning equipment, uniformity of product temperature may be ensured by the temperature control medium provided in the hollow channel 200 and product deformation may be minimized. Further, no interface between the hollow channel 200 and the hole 20′ exists by the weld zone w formed between the hollow channel 200 and the hole 20′, thus making it possible to prevent an adverse action therebetween.

The semiconductor manufacturing process equipment or display manufacturing process equipment including the joined component 101 may be heat treatment equipment. The joined component 101 may supply a process fluid for a heat treatment process to a workpiece. The process fluid may be supplied through the hole 20′. The heat treatment equipment including the joined component 101 may apply heat at a high speed to activate dopants implanted by a method such as ion implantation and may form an oxide film, a nitride film, and the like.

When the joined component 101 is provided in the heat treatment equipment, uniformity of product temperature may be ensured by the temperature control medium provided in the hollow channel 200 in which no interface exists at an inner surface thereof by the weld zone w formed by welding first and second parent members 1a and 1b by friction stir welding. Therefore, it is possible to minimize deformation of a product.

The joined component 101 may be formed in a structure in which the hole 20′ avoids interference with the hollow channel 200. As a result, an adverse action between the hole 20′ and the hollow channel 200 may be blocked, and a more efficient structure may be formed inside the joined component 101.

The semiconductor manufacturing process equipment or display manufacturing process equipment including the joined component 101 may be ion implantation equipment. The joined component 101 may be a joined component 101 for supplying a process fluid for an ion implantation process to a workpiece. The ion implantation equipment including the joined component 101 may actively pressurize impurity atoms (preferably 3 to 5) to give a certain electrical resistance onto the surface of a wafer or glass.

When the joined component 101 is provided in the ion implantation equipment, uniformity of product temperature may be ensured by the temperature control medium provided in the hollow channel 200. Therefore, it is possible to minimize deformation of a product. Further, respective lower sections of holes 20′ located at a lower portion of the joined component 101 may be arranged at a regular pitch to efficiently form a structure that does not interfere with the hollow channel 200, thereby improving functional and structural efficiency.

The semiconductor manufacturing process equipment or display manufacturing process equipment including the joined component 101 may be sputtering equipment. The joined component 101 may supply a process fluid for a sputtering process to a workpiece, and the process fluid may pass through the hole 20′ in which no interface exists at the inner surface thereof. The sputtering equipment including the joined component 101 may form a metal film on the surface of a wafer or glass using a sputter profile.

When the joined component 101 of the embodiment is provided in the sputtering equipment, uniformity of product temperature may be ensured by the temperature control medium provided in the hollow channel 200. Therefore, it is possible to minimize deformation of a product. Further, the hole 20′ may be formed in a structure that does not interfere with the hollow channel 200 and allows the process fluid to be uniformly sprayed, thus making it possible to increase functional efficiency.

The semiconductor manufacturing process equipment or display manufacturing process equipment including the joined component 101 may be CVD equipment. The joined component 101 may supply a process fluid for a heat treatment process to a workpiece. The CVD equipment including the joined component 101 may be used to deposit a thin film on the surface of a wafer or glass by chemical reaction occurring in electrons or vapor phases by exciting a reaction process fluid composed of elements with energy, such as a thermal plasma discharge, photo-discharge, or the like. The CVD equipment may be atmospheric pressure CVD equipment, reduced pressure CVD equipment, plasma CVD equipment, photo-initiated CVD equipment, or MO-CVD equipment.

The joined component 101 provided in the CVD equipment as the semiconductor manufacturing process equipment may be a showerhead, and the joined component 101 provided in the CVD equipment as the display manufacturing process equipment may be a diffuser.

The joined component 101 provided in the CVD equipment may spray the process fluid with a structure in which the hollow channel 200 and the hole 20′ do not adversely influence each other in the functional and structural aspects by the weld zone w. Due to such a structure, process fluid injection efficiency of the joined component 101 may be improved.

As described above, the joined component 101 according to the present invention, which is formed in a structure that emphasizes the aspect of temperature control, is formed in a structure in which the hole 20′ does not interfere with the hollow channel 200 and is isolated therefrom functionally and structurally by the weld zone w. Due to such a structure, not only efficiency of a process fluid spraying function, but also structural efficiency of forming the joined component 101 may be improved.

As illustrated in FIG. 21B, the semiconductor manufacturing process equipment or display manufacturing process equipment may include the joined component 107.

In this case, the joined component 107 may be provided in semiconductor manufacturing process equipment or display manufacturing process equipment including etching equipment, cleaning equipment, heat treatment equipment, ion implantation equipment, sputtering equipment, or CVD equipment, and may spray different process fluids through first and second fluid holes 20 and 30 separately.

The joined component 107 may be provided in the semiconductor manufacturing process equipment or display manufacturing process equipment to perform a process associated with each equipment using a first process fluid passing through the first fluid hole 20 and a second process fluid passing through the second fluid hole 30.

The joined component 107 differs from the joined component 101 formed with a structure that emphasizes the aspect of temperature control in that the joined component 107 is provided in etching equipment, cleaning equipment, heat treatment equipment, ion implantation equipment, sputtering equipment, or CVD equipment to spray the first process fluid and the second process fluid separately.

Since the joined component 107 is provided in the semiconductor manufacturing process equipment or display manufacturing process equipment to supply the first and second process fluids separately, it is possible to prevent the problem that in the related art, the process fluids injected into a fluid passing member in a mixed state may react in the fluid passing member before spraying, causing undesired chemical reaction to occur.

Further, no interface exists between the first and second fluid holes 20 and 30 by a weld zone w formed between the first and second fluid holes 20 and 30. Therefore, an adverse action between the first and second fluid holes 20 and 30 due to the interface may be prevented, thereby increasing functional efficiency of the joined component 107.

The joined components according to embodiments and modifications of the present invention may be formed in a structure in which flow paths provided therein (e.g., the hole 20′ and the hollow channel 200 in a structure that emphasizes the aspect of temperature control, and the first and second fluid holes 20 and 30 in a structure that emphasizes the aspect of spraying of different process fluids) are not in communication with each other by the weld zone w. Therefore, an adverse action between the flow paths may be prevented.

Further, the joined components may be formed in a structure in which the flow paths do not interfere with each other so as to perform their functions more efficiently, thus making it possible to improve functional and structural efficiency of the joined components.

Although exemplary embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A joined component formed by welding at least two parent members by friction stir welding, the joined component comprising:
a hollow channel formed inside the joined component and including a temperature control medium therein; and
a hole passing through the parent members from top to bottom and through which a first process fluid passes,
wherein a weld zone formed by the friction stir welding removes at least a part of an interface between the hollow channel and the hole, and
the hole passes through a remaining region except for a unwelded interface existing in a hollow channel region in which the hollow channel is formed.

2. The joined component of claim 1, wherein the hole passes through the parent members from top to bottom and is configured such that upper and lower portions of the hole are not located on the same vertical line but are located eccentrically with respect to each other.

3. The joined component of claim 1, wherein at least a part of the hole is formed to be inclined.

4. The joined component of claim 1, wherein the hole is configured such that a lower section located at a lower portion of the joined component is formed within a range of a vertical projection region of an interface of the parent members.

5. The joined component of claim 1, wherein the hole is formed to be inclined within a range of a vertical projection region of the unwelded interface of the parent members.

6. The joined component of claim 1, wherein the hole comprises a plurality of holes, and the holes are configured such that respective lower sections thereof located at a lower portion of the joined component are arranged at a regular pitch.

7. The joined component of claim 1, wherein at least a part of the hole passes through the weld zone formed by the friction stir welding.

8. The joined component of claim 1, wherein the parent members comprises:
a first parent member including a first groove region in which a first groove is formed and a first non-groove region in which the first groove is not formed;
a second parent member located on one surface of the first parent member, and including a second groove region in which a second groove is formed and a second non-groove region in which the second groove is not formed; and
a third parent member located on one surface of the second parent member,
wherein the hollow channel is formed as a plurality of layers inside the joined component by the first groove and the second groove.

9. The joined component of claim 1, wherein the weld zone formed by the friction stir welding comprises weld zones formed along respective hollow channels such that an overlap portion is formed by the weld zones that overlap with each other at least partially.

10. The joined component of claim 1, further comprising:
a communication line formed inside the joined component and being in communication with the hollow channel.

11. The joined component of claim 1, wherein the temperature control medium is a fluid or a heating wire.

12. The joined component of claim 1, wherein the temperature control medium is a heating or cooling medium.

13. A joined component formed by welding at least two parent members by friction stir welding, the joined component comprising:
a first fluid hole passing through the parent members from top to bottom and through which a first process fluid passes; and
a second fluid hole being in communication with a first hollow channel formed inside the joined component, and through which a second process fluid passes,
wherein a weld zone formed by the friction stir welding removes at least a part of an interface between the first and second fluid holes, and
the first fluid hole passes through a remaining region except for a unwelded interface existing in a first hollow channel region in which the first hollow channel is formed.

14. The joined component of claim 13, wherein the first fluid hole passes through the parent members from top to bottom and is configured such that upper and lower portions of the first fluid hole are not located on the same vertical line but are located eccentrically with respect to each other.

15. The joined component of claim 13, wherein at least a part of the first fluid hole is formed to be inclined.

16. The joined component of claim 13, wherein the first fluid hole is configured such that a lower section located at a lower portion of the joined component is formed within a range of a vertical projection region of an interface of the parent members.

17. The joined component of claim 13, wherein the first fluid hole and the second fluid hole comprise a plurality of first fluid holes and a plurality of second fluid holes, respectively, and the first and second fluid holes are configured such that respective lower sections thereof located at a lower portion of the joined component are arranged at a regular pitch and different process fluids are supplied through the first and second fluid holes separately.

18. The joined component of claim 13, further comprising:
a second hollow channel formed inside the joined component and including a temperature control medium therein.

19. The joined component of claim 13, wherein the weld zone formed by the friction stir welding comprises weld zones configured such that an overlap portion is formed the weld zones that overlap with each other at least partially.

20. The joined component of claim 13, further comprising:
a communication line formed inside the joined component and being in communication with the first hollow channel.
